(19) United States
(12) Patent Application Publication
(10) Pub. No.: US 2025/0022044 A1
(43) Pub. Date: Jan. 16, 2025

(54) APPARATUS, METHOD, AND SYSTEM

(71) Applicant: PLAYGROUND CO., LTD., Tokyo (JP)

(72) Inventor: Keiji ITO, Tokyo (JP)

(73) Assignee: PLAYGROUND CO., LTD., Tokyo (JP)

(21) Appl. No.: 18/899,242

(22) Filed: Sep. 27, 2024

Related U.S. Application Data
(63) Continuation of application No. PCT/JP2023/015015, filed on Apr. 13, 2023.

(30) Foreign Application Priority Data
Apr. 19, 2022 (JP) 2022-068683
Apr. 19, 2022 (JP) 2022-068695

(51) Int. Cl. G06Q 30/0601; G06Q 20/12

(52) U.S. Cl. CPC G06Q 30/0643; G06Q 20/123

(57) ABSTRACT

An apparatus includes circuitry. The circuitry identify information on a user. The circuitry detect that an article purchased by the user and related to an event held in a real space is handed over to the user at an event venue. The circuitry provide a virtual item usable in a virtual space to the user who has received the article.

### CROSS-REFERENCE TO RELATED APPLICATIONS

This application is based upon and claims the benefit of priority from the prior Japanese Patent Application No. 2022-068683, filed Apr. 19, 2022, Japanese Patent Application No. 2022-068695, filed Apr. 19, 2022, and PCT Patent Application No. PCT/JP2023/015015, filed Apr. 13, 2023, the entire contents of all of which are incorporated herein by reference.

### FIELD

The present disclosure relates to an apparatus, a method, a system, and an article provision apparatus.

### BACKGROUND

There is a system that invigorates an event using information on the sales of related goods sold at an event venue. For example, players' provisional prize money is calculated from the sales of related goods sold at the event venue. The event participants' purchase of related goods thus enhances cooperation between the event participants and the event organizer, thereby invigorating the event. The technique also involves returning a certain fraction of the prize money to the participants to prompt the purchase of related goods.

Part of the sales of related goods purchased by all the event participants is returned to the individual event participants. The technique could be improved upon with respect to motivating participants to purchase event-related articles.

An object of the present disclosure is to promote the sales of event-related articles.

### BRIEF DESCRIPTION OF DRAWINGS

FIG. 1 is a block diagram illustrating the configuration of an information processing system according to a first embodiment.

FIG. 2 is a block diagram illustrating the configuration of a user terminal according to the first embodiment.

FIG. 3 is a block diagram illustrating the configuration of a ticket management server according to the first embodiment.

FIG. 4 is a block diagram illustrating the configuration of an item management server according to the first embodiment.

FIG. 5A is a diagram illustrating a management terminal according to the first embodiment.

FIG. 5B is a block diagram illustrating the configuration of a management terminal according to the first embodiment.

FIG. 6 is a diagram illustrating the configuration of a distributed ledger system according to the first embodiment.

FIG. 7 is a diagram for describing an aspect of the first embodiment.

FIG. 8A is a diagram for describing another aspect of the first embodiment.

FIG. 8B is a diagram for describing another aspect of the first embodiment.

FIG. 9A is a diagram illustrating exemplary data structures of a ticket database according to the first embodiment.

FIG. 9B is a diagram illustrating exemplary data structures of a user database according to the first embodiment.

FIG. 9C is a diagram illustrating exemplary data structures of a physical item master database according to the first embodiment.

FIG. 10A is a diagram illustrating exemplary data structures of an individual physical item database according to the first embodiment.

FIG. 10B is a diagram illustrating exemplary data structures of a virtual item master database according to the first embodiment.

FIG. 10C is a diagram illustrating exemplary data structures of an individual virtual item database according to the first embodiment.

FIG. 11A is a diagram illustrating exemplary data structures of a use history database according to the first embodiment.

FIG. 11B is a diagram illustrating exemplary data structures of an activity history database according to the first embodiment.

FIG. 12 is a diagram illustrating an exemplary data structure of an activity evaluation rule database according to the first embodiment.

FIG. 13 is a flowchart of article sale processing according to the first embodiment.

FIG. 14 is a flowchart of virtual-item provision processing according to the first embodiment.

FIG. 15 is a flowchart of the processing of obtaining user gear information according to the first embodiment.

FIG. 16 is a flowchart of the processing of obtaining user activity information according to the first embodiment.

FIG. 17A is a diagram illustrating a management terminal in the information processing system according to a variation.

FIG. 17B is a block diagram illustrating the configuration of a management terminal in the information processing system according to a variation.

FIG. 18 is a flowchart of article sale processing and virtual-item provision processing according to the variation.

FIG. 19 is a block diagram illustrating the configuration of an information processing system according to a second embodiment.

FIG. 20A is an article provision device.

FIG. 20B is a block diagram illustrating the configuration of an article provision device.

FIG. 21 is a flowchart of article sale processing according to the second embodiment.

FIG. 22 is a flowchart of virtual-item provision processing according to the second embodiment.

### DETAILED DESCRIPTION

In general, an apparatus includes circuitry. The circuitry identify information on a user. The circuitry detect that an article purchased by the user and related to an event held in a real space is handed over to the user at an event venue. The circuitry provide a virtual item usable in a virtual space to the user who has received the article.

### First Embodiment

A first embodiment of the present invention will be described in detail below with reference to the drawings. Throughout the drawings for describing the embodiment, like elements are generally given like symbols and will not be repeatedly described.

### (1) Configuration of Information Processing System 1

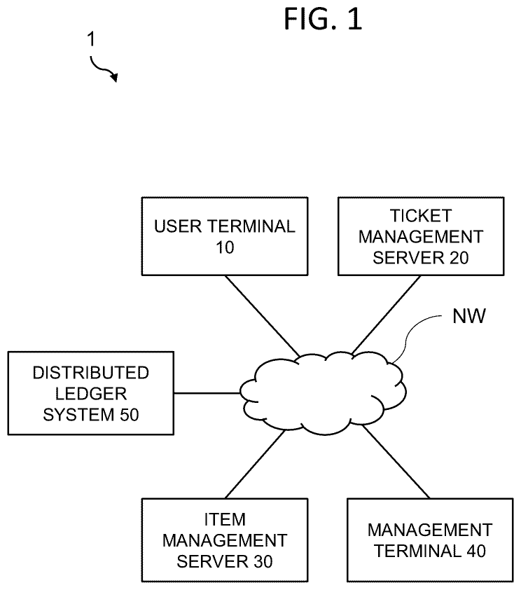

The configuration of an information processing system 1 (which may hereinafter simply be referred to as a system 1) according to this embodiment will be described. FIG. 1 is a block diagram illustrating the configuration of the information processing system 1 according to the first embodiment.

As illustrated in FIG. 1, the information processing system 1 includes a user terminal 10, a ticket management server 20, an item management server 30, a management terminal 40, and a distributed ledger system 50.

The user terminal 10, the ticket management server 20, the item management server 30, the management terminal 40, and the distributed ledger system 50 are interconnected via a network (e.g., the Internet) NW.

The user terminal 10 is an example of an information processing device that transmits requests to the item management server 30. The user terminal 10 is, for example, a smartphone, a tablet terminal, or a personal computer. The user of the user terminal 10 is a participant in an event, such as a function or a show.

Exemplary events managed by the system 1 include the following.
music events, such as concerts and lives
sport events, such as ball game events, swimming events, and martial arts events (including professional league games and amateur competitions)
gaming competitions held at real event venues
entertainment events, including stage plays, comic dialogue events, rakugo events, and other performing-art events
exhibitions, such as trade fairs, product exhibitions, and flea markets
expositions, such as world expositions and regional expositions
exhibitions, such as art exhibitions and natural history exhibitions
government-controlled gambles
municipally hosted events, such as local festivals and commemorative events
school festivals, and performance programs of circles and groups
events held at amusement parks
events held temporarily in department stores and public areas

The event is not limited to the above examples. The event may be held regularly, irregularly, or at all times.

The following description takes a concert as an exemplary event.

The ticket management server 20 is an example of an information processing device. The ticket management server 20 provides, to the user terminal 10, responses to requests transmitted by the user terminal 10. The ticket management server 20 provides, to the management terminal 40, responses to requests transmitted by the management terminal 40. The ticket management server 20 is, for example, a web server. The user of the ticket management server 20 is, for example, the operator of the information processing system 1.

The item management server 30 is an example of an information processing device.

The item management server 30 provides, to the user terminal 10, responses to requests transmitted by the user terminal 10. The item management server 30 provides, to the management terminal 40, responses to requests transmitted by the management terminal 40. The item management server 30 is, for example, a web server. The user of the item management server 30 is, for example, the operator of the information processing system 1.

The management terminal 40 is an example of an information processing device that transmits requests to the item management server 30. The management terminal 40 is, for example, a smartphone, a tablet terminal, or a personal computer. The user of the management terminal 40 is, for example, event staff engaged in event operation.

The distributed ledger system 50 manages distributed ledgers according to requests from the user terminal 10, the ticket management server 20, the item management server 30, or the management terminal 40.

### (1-1) Configuration of User Terminal 10

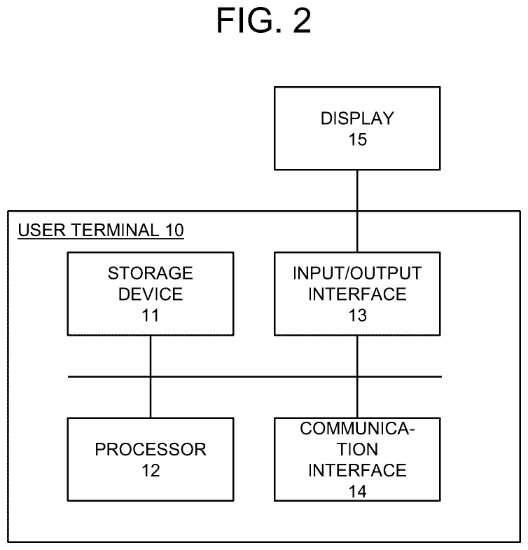

The configuration of the user terminal 10 will be described. FIG. 2 is a block diagram illustrating the configuration of the user terminal 10 according to the first embodiment.

As illustrated in FIG. 2, the user terminal 10 includes a storage device 11, a processor 12, an input/output interface 13, and a communication interface 14. The user terminal 10 is connected to a display 15.

The storage device 11 is configured to store programs and data. The storage device 11 is, for example, a combination of read only memory (ROM), random access memory (RAM), and storage (e.g., a flash memory or a hard disk).

Examples of the programs include the following.
programs of an operating system (OS)
programs of applications (e.g., a web browser) that perform information processing Examples of the data include the following.
databases referred to in information processing
data resulting from performing information processing (i.e., results of performing information processing)

The processor 12 is a computer that implements the functions of the user terminal 10 by executing programs stored in the storage device 11. The processor 12 is, for example, at least one of the following.
a central processing unit (CPU)
a graphics processing unit (GPU)
an application specific integrated circuit (ASIC)
a field programmable gate array (FPGA)

The input/output interface 13 is configured to obtain information (e.g., a user instruction) from an input device connected to the user terminal 10 and to output information (e.g., an image) to an output device connected to the user terminal 10.

The input device is, for example, a keyboard, a pointing device, a touch panel, or a combination thereof.

The output device is, for example, the display 15, a speaker, or a combination thereof.

The communication interface 14 is configured to control communication between the user terminal 10 and external devices (e.g., the ticket management server 20, the item management server 30, the management terminal 40, and the distributed ledger system 50).

The display 15 is configured to display images (still images or videos). The display 15 is, for example, a liquid crystal display or an organic EL display.

### (1-2) Configuration of Ticket Management Server 20

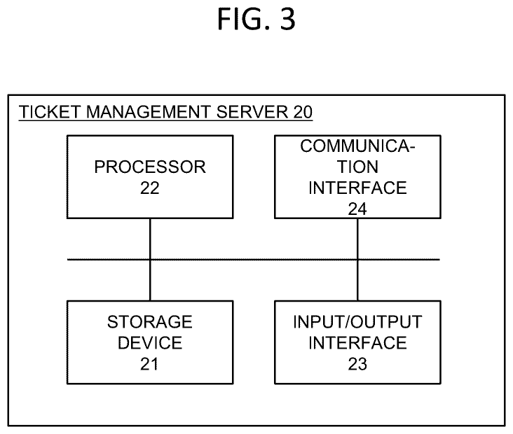

The configuration of the ticket management server 20 will be described. FIG. 3 is a block diagram illustrating the configuration of the ticket management server 20 according to the first embodiment.

As illustrated in FIG. 3, the ticket management server 20 includes a storage device 21, a processor 22, an input/output interface 23, and a communication interface 24.

The storage device 21 is configured to store programs and data. The storage device 21 is, for example, a combination of ROM, RAM, and storage (e.g., a flash memory or a hard disk).

Examples of the programs include the following.
programs of an OS
programs of applications that perform information processing

Examples of the data include the following.
databases referred to in information processing
results of performing information processing

The processor 22 is a computer that implements the functions of the ticket management server 20 by executing programs stored in the storage device 21. The processor 22 is, for example, at least one of the following.
a CPU
a GPU
an ASIC
an FPGA

The input/output interface 23 is configured to obtain information (e.g., a user instruction) from an input device connected to the ticket management server 20 and to output information (e.g., an image) to an output device connected to the ticket management server 20.

The input device is, for example, a keyboard, a pointing device, a touch panel, or a combination thereof.

The output device is, for example, a display, a speaker, or a combination thereof.

The communication interface 24 is configured to control communication between the ticket management server 20 and external devices (e.g., the user terminal 10, the item management server 30, the management terminal 40, and the distributed ledger system 50).

### (1-3) Configuration of Item Management Server 30

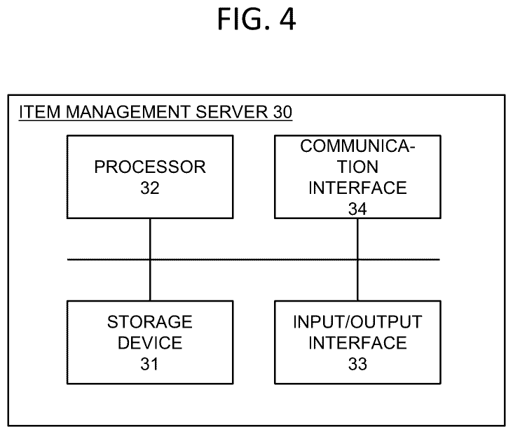

The configuration of the item management server 30 will be described. FIG. 4 is a block diagram illustrating the configuration of the item management server 30 according to the first embodiment.

As illustrated in FIG. 4, the item management server 30 includes a storage device 31, a processor 32, an input/output interface 33, and a communication interface 34.

The storage device 31 is configured to store programs and data. The storage device 31 is, for example, a combination of ROM, RAM, and storage (e.g., a flash memory or a hard disk).

Examples of the programs include the following.
programs of an OS
programs of applications that perform information processing

Examples of the data include the following.
databases referred to in information processing
results of performing information processing

The processor 32 is a computer that implements the functions of the item management server 30 by executing programs stored in the storage device 31. The processor 32 is, for example, at least one of the following.
a CPU
a GPU
an ASIC
an FPGA

The input/output interface 33 is configured to obtain information (e.g., a user instruction) from an input device connected to the item management server 30 and to output information (e.g., an image) to an output device connected to the item management server 30.

The input device is, for example, a keyboard, a pointing device, a touch panel, or a combination thereof.

The output device is, for example, a display, a speaker, or a combination thereof.

The communication interface 34 is configured to control communication between the item management server 30 and external devices (e.g., the user terminal 10, the ticket management server 20, the management terminal 40, and the distributed ledger system 50).

### (1-4) Configuration of Management Terminal 40

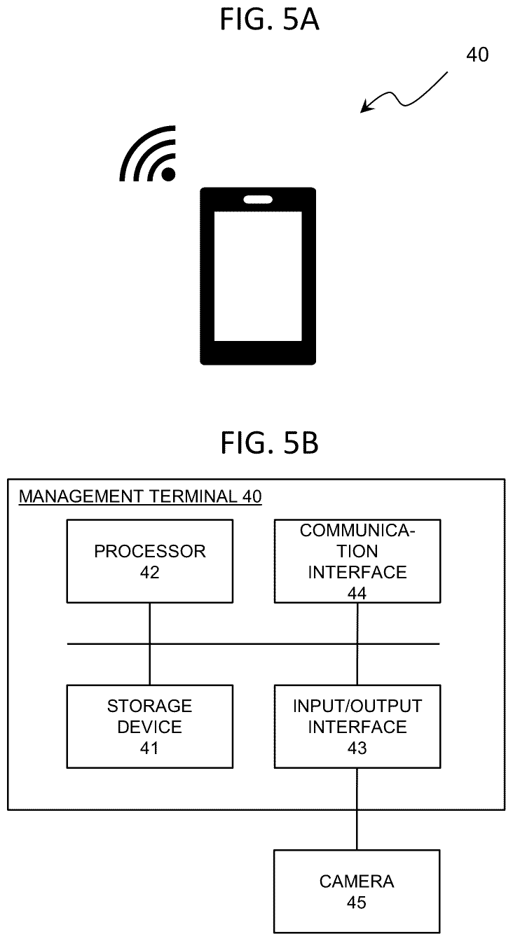

The configuration of the management terminal 40 will be described. FIG. 5B is a block diagram illustrating the configuration of the management terminal 40 according to the first embodiment.

As illustrated in FIG. 5B, the management terminal 40 includes a storage device 41, a processor 42, an input/output interface 43, a communication interface 44, and a camera 45.

The storage device 41 is configured to store programs and data. The storage device 41 is, for example, a combination of ROM, RAM, and storage (e.g., a flash memory or a hard disk).

Examples of the programs include the following.
programs of an OS
programs of applications (e.g., a web browser) that perform information processing Examples of the data include the following.
databases referred to in information processing
data resulting from performing information processing (i.e., results of performing information processing)

The processor 42 is a computer that implements the functions of the management terminal 40 by executing programs stored in the storage device 41. The processor 42 is, for example, at least one of the following.
a CPU
a GPU
an ASIC
an FPGA

The input/output interface 43 is configured to obtain information (e.g., a user instruction) from an input device connected to the management terminal 40 and to output information (e.g., an image) to an output device connected to the management terminal 40.

The input device is, for example, a keyboard, a pointing device, a touch panel, or a combination thereof.

The output device is, for example, a display, a speaker, or a combination thereof.

The communication interface 44 is configured to control communication between the management terminal 40 and external devices (e.g., the user terminal 10, the ticket management server 20, the item management server 30, and the distributed ledger system 50).

The camera 45 inputs, to the input/output interface 43, image data obtained with an imaging module.

### (1-5) Configuration of Distributed Ledger System 50

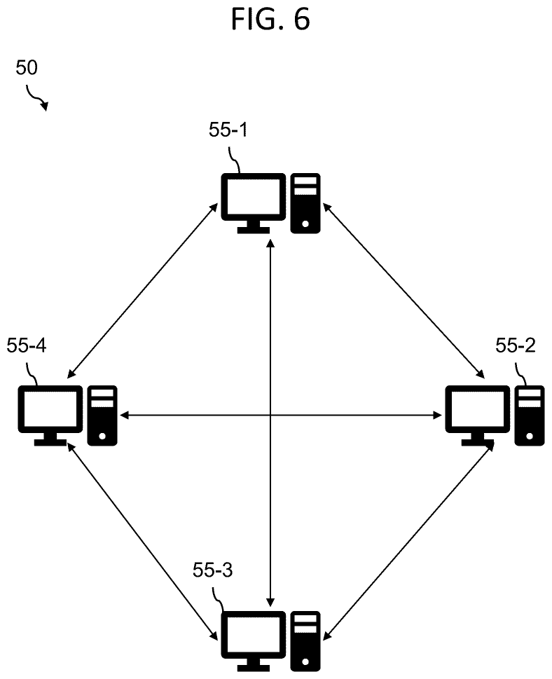

The configuration of the distributed ledger system 50 will be described. FIG. 6 is a diagram illustrating the configuration of the distributed ledger system 50 according to the first embodiment.

As illustrated in FIG. 6, the distributed ledger system 50 includes multiple node computers 55-1 to 55-4.

The node computers 55 are interconnected via a network (which may include the network NW in FIG. 1). In this embodiment, the network may include a public network, a private network, a dedicated line, a virtual private network (VPN), or a combination thereof.

The node computers 55 are connected to the network through, for example, wired or wireless connection. The node computers 55 communicate with each other in a peer-to-peer manner.

The node computers 55 manage distributed ledgers using, for example, a blockchain technology.

Specifically, any of the node computers 55 obtains token transaction data to be recorded. The node computer 55 creates a block including the obtained data and adds the block to a blockchain. The node computer 55 transmits information on the added block to the other node computers 55. The other node computers 55 each verify the correctness of the received block and, upon succeeding in the verification, add the block to a blockchain. The node computers 55 confirm the blockchain based on, for example, the number of connected blocks (the number of approvals). Thus, the node computers 55 constituting the distributed ledger system 50 store the same distributed ledger. The stored data is encrypted as appropriate.

The distributed ledger system 50 is not limited to the form illustrated in FIG. 6. For example, the distributed ledger system 50 may include five or more node computers 55, or two or three node computers 55. The number of node computers 55 constituting the distributed ledger system 50 may vary over time.

The hardware configuration of the node computers 55 may be the same as or similar to that of any of the above-described terminals and servers, and therefore will not be described in detail. As an example, the node computers 55 each include a processor, a storage device, an input/output interface, a communication interface, an input device, and an output device, or any combination thereof.

### (2) Overview of Embodiment

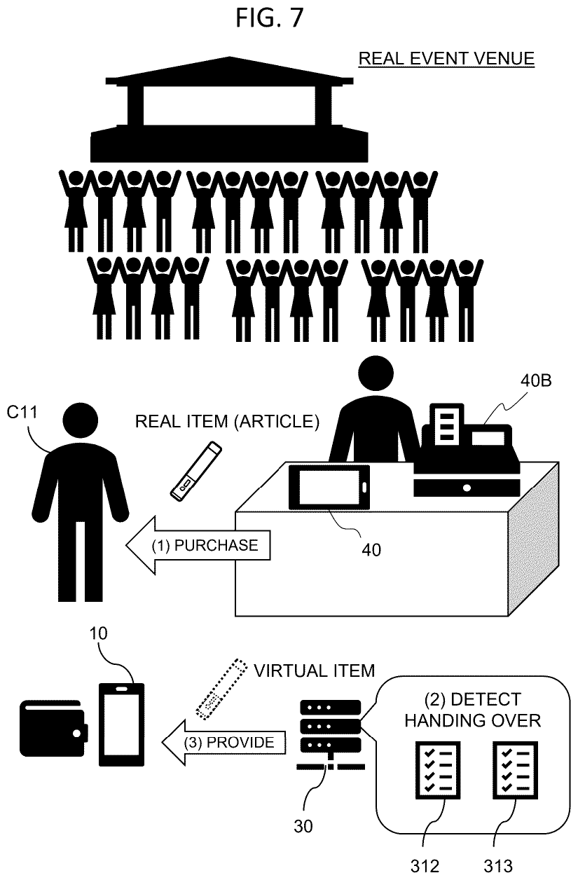

An overview of the first embodiment will be described. FIG. 7 is a diagram for describing an aspect of the first embodiment.

### (2-1) Aspect of Embodiment

As illustrated in FIG. 7, the system 1 manages the sale of articles at an event venue. In this description, articles are real items related to an event, and examples of the articles include the following.
concert goods (such as T-shirts, towels, light sticks, cheering paper fans, event posters, artists' photos, key rings, dolls, accessories, and bottle caps) for a concert event
cheering goods (such as uniforms, megaphones, balloons, whistles, banners, and pins) for a sport event
theatrical-performance goods (such as program pamphlets, stage photos, actors' photos, special tickets, and figures) for a stage play event

The specifics of the articles are not limited to the above and include all event-related real items sold or handed over at merchandise booths in the event venue.

A user C11 purchases a cheering item, for example a light stick, at a merchandise booth in the event venue. At this point, an event staffer operates the management terminal 40 (or a management terminal 40B to be described later) to cause the item management server 30 to detect the handing over of the article.

In response to detecting the handing over of the article, the item management server 30 provides a virtual item to the user C11.

Virtual items herein are digital content usable in a virtual space. For example, virtual items in a virtual event held in a virtual space include clothes worn by avatars representing users in the virtual space, and cheering goods used by the avatars in the virtual event.

In providing a virtual item, specifically, the item management server 30 causes the distributed ledger system 50 to register the content data on the virtual item, and user information (e.g., information on a wallet of the user), associated with each other in a distributed ledger. Information on the transaction sequence is recorded as transaction data in the distributed ledger, which is identified by the value of “ledger ID” in an individual virtual item DB 315.

That is, a virtual item has a characteristic of a non-fungible token (NFT) for which owner information is managed in a distributed ledger. A virtual item is tradable and can be transferred to another user at the request of its owner.

When a virtual item is transferred to another user, information on the new owner is registered by the distributed ledger system 50 as the owner information in a distributed ledger. The distributed ledger records the history of the owners of the virtual item. Referring to the distributed ledger reveals the transitions of the owners of the virtual item.

A virtual item may be traded in a system (which may be called, e.g., a private chain or a second layer) external to the distributed ledger system 50. In this case, the virtual item may be traded using information capable of identifying the system in which the user's virtual item is actually traded, and information on the wallets of the relevant customers in the system.

The virtual item provided by the item management server 30 to the user C11 desirably corresponds to the real item. A virtual item corresponding to a real item refers to a virtual item having the same generic name (common name of an item) as a real item, or being in the same category (category defined by the use or function) as a real item.

As an example of a virtual item having the same generic name as a real item, the user C11 may purchase a light stick as a real item and receive a light stick as a virtual item.

As an example of a virtual item in the same category as a real item, the user C11 may purchase a light stick as a real item and receive a cheering paper fan as a virtual item, which belongs to the same category “cheering goods” as the light stick. If the user receives a virtual item in the same category as the real item, the user may receive a predetermined or randomly chosen one of the virtual items belonging to the same category, or may select any one of those virtual items as the user desires.

It is to be noted that the item management server 30 may provide a virtual item not corresponding to the real item to the user C11.

The system 1 thus provides a virtual item as a special favor in response to detecting the handing over of an article at the event venue. This stimulates fans' desires to collect virtual items, thereby prompting them to go to the event venue.

### (2-2) Another Aspect of Embodiment

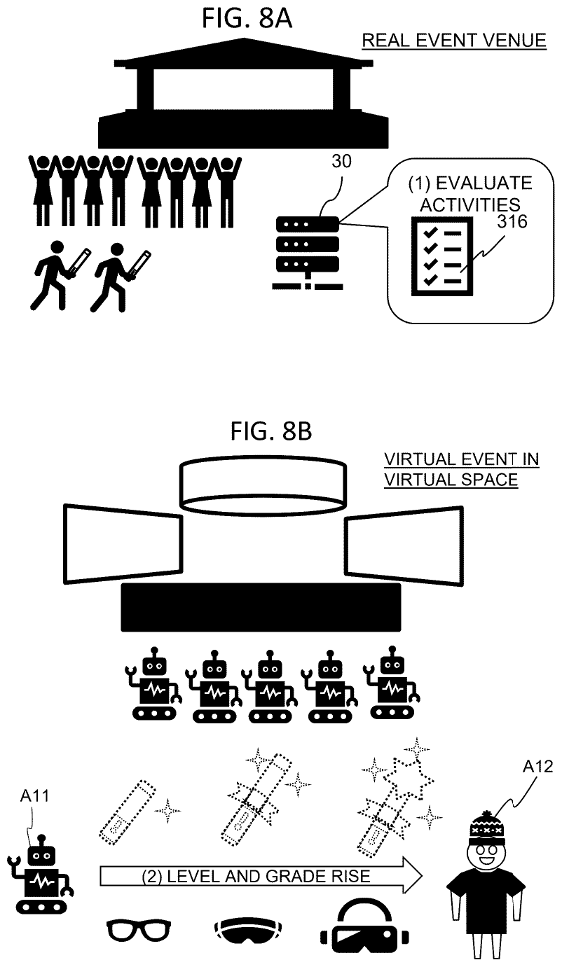

FIG. 8A is a diagram for describing another aspect of the first embodiment. FIG. 8B is a diagram for describing another aspect of the first embodiment.

Gears worn or used by users coming to an event may create a sense of unity or togetherness in the event; examples of such gears may be uniforms worn by spectators at a sport game, or light sticks used by audiences at an indoor concert. As such, it is desirable that purchased articles are actively used as gears in participating in the event. In the following description, gears refer to articles used at an event venue, among other articles owned by users.

As illustrated in FIG. 8A and FIG. 8B, the system 1 obtains information on gears of a user participating in an event held at a real event venue. Depending on the user's activity using the gears, the system 1 provides special favors in a virtual space, for example points, to the user to prompt the user to use articles purchased.

The system 1 obtains information on the user's activity at the real event venue and evaluates the user's activity based on an activity evaluation rule DB 318 to be described below. If it is determined that the activity satisfies a predetermined condition, the system 1 gives points to the user, for example to the user's account in the virtual space, as a special favor in the virtual space. For example, if a user performs a predetermined action at the real event venue illustrated in FIG. 8A and FIG. 8B using a light stick purchased by the user, the item management server 30 evaluates it as a contribution to enlivening the event and gives points to the user as a reward.

The user's account in the virtual space has at least one avatar, which is an object representing the user in the virtual space. Multiple avatars may be set for a single account.

As special favors, the item management server 30 gives points to the user's avatar and virtual items in the virtual space. The score of the avatar (hereinafter referred to as an avatar score) is associated with the level of the avatar (hereinafter referred to as an avatar level). The avatar level rises with the avatar score. As illustrated in FIG. 8A and FIG. 8B, as the avatar level rises, the user is allowed to change the appearance of the avatar A11 to suit the user's preference, for example update the avatar A11 to a new avatar A12. That is, as the level of the user's account rises with addition of points to the user, the system 1 presents choices selectable by the user to change the avatar's appearance as the user desires. Changing the appearance here includes partially modifying the appearance.

Not only may the avatar's appearance be changed, but the avatar's ability may be improved as the level of the user's account rises. For example, the avatar may acquire the ability to perform a special move, such as a dance move for cheering an artist.

The score of a virtual item (hereinafter referred to as an item score) is associated with the grade of the virtual item (hereinafter referred to an item grade). The item grade rises with the item score. As illustrated in FIG. 8A and FIG. 8B, as the item grades of a light stick and goggles rise, these virtual items are restyled. That is, as the grade of a virtual item rises with addition of points to the virtual item, the system 1 restyles the appearance of the virtual item.

As the grade of a virtual item rises, the user may acquire the ability to perform a more special move using the virtual item.

The system 1 thus evaluates the user's gears and activities at the event venue to prompt the user to actively use articles purchased.

In the following description, a real article may be referred to as a “physical item” as an antonymic expression for a “virtual item.”

### (3) Databases

Databases according to the first embodiment will be described.

### (3-1) Ticket Database 211

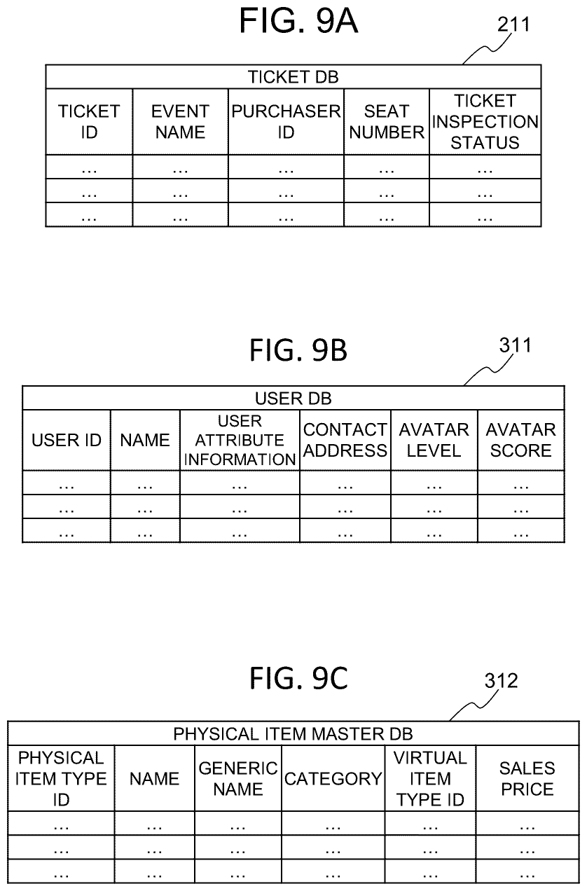

A ticket database (DB) 211 according to the first embodiment will be described. FIG. 9A illustrates the data structure of the ticket DB 211 according to the first embodiment. The ticket DB 211 is stored in the storage device 21 of the ticket management server 20.

The ticket DB 211 is a database that stores and manages information on tickets required for participating in events. In the ticket DB 211, a new record is created when a ticket for a hosted event is sold. The ticket DB 211 includes the columns “ticket ID,” “event name,” “purchaser ID,” “seat number,” and “ticket inspection status.”

The column “ticket ID” stores identification information for identifying tickets for events. Ticket IDs are values uniquely set for the respective tickets.

The column “event name” stores the names of the events in which users are allowed to participate using the tickets corresponding to the ticket IDs.

The column “purchaser ID” stores identification information on the users who purchased the tickets corresponding to the ticket IDs.

The column “seat number” stores information on the locations of seats at the event venues, specified by the tickets corresponding to the ticket IDs.

The column “ticket inspection status” stores information indicating whether the tickets corresponding to the ticket IDs have been inspected (collected).

### (3-2) User Database 311

A user database (DB) 311 according to the first embodiment will be described. FIG. 9B illustrates the data structure of the user DB 311 according to the first embodiment. The user DB 311 is stored in the storage device 31 of the item management server 30.

The user DB 311 is a database that stores and manages user information. In the user DB 311, a new record is created when a user joins the system 1. The user DB 311 includes the columns “user ID,” “name,” “user attribute information,” “contact address,” “avatar level,” and “avatar score.”

The column “user ID” stores identification information for identifying users. User IDs are values uniquely set for the respective users.

The column “name” stores the names of the users corresponding to the user IDs.

The column “user attribute information” stores attribute information (predetermined items such as sex, age, occupation, place of residence, nationality, and native language) on the users corresponding to the user IDs.

The column “contact address” stores the means of contacting the users corresponding to the user IDs (such as e-mail addresses).

The column “avatar level” stores the levels of the avatars in a virtual space of the users corresponding to the user IDs. The avatar level is set based on the avatar score. For example, the level value increases with the score value such that the score values 0 to 200 correspond to the level 1, and the score values 201 to 400 correspond to the level 2.

The column “avatar score” stores the scores associated with the avatar levels of the users corresponding to the user IDs.

### (3-3) Physical Item Master Database 312

A physical item master database (DB) 312 according to the first embodiment will be described. FIG. 9C illustrates the data structure of the physical item master DB 312 according to the first embodiment. The physical item master DB 312 is stored in the storage device 31 of the item management server 30.

The physical item master DB 312 is a database that stores and manages information on the types of real articles (physical items) to be sold in relation to holding an event. In the physical item master DB 312, a new record is created when a type of physical items is determined to go on sale. The physical item master DB 312 includes the columns “physical item type ID,” “name,” “generic name,” “category,” “virtual item type ID,” and “sales price.”

The column “physical item type ID” stores identification information for identifying the types of physical items. Physical item type IDs are values uniquely set for the respective types of physical items.

The column “name” stores the product names (the names) of the types of physical items corresponding to the physical item type IDs. The product names of the physical items may include the model number, the product series name, and the product proper noun that are assigned by the manufacturers.

The column “generic name” stores the common names (the generic names) of the types of physical items corresponding to the physical item type IDs. The common names of the physical items may include “cap,” “towel,” “event poster,” “light stick,” and “cheering paper fan.”

The column “category” stores categories that are set according to categorization by the uses or functions of the types of physical items corresponding to the physical item type IDs. Examples of the categories of physical items may include “clothes,” “souvenir,” and “cheering goods.” The categories may be set as appropriate.

The column “virtual item type ID” stores the types of virtual items to be provided in response to the handing over of the types of physical items corresponding to the physical item type IDs. Registered in the column “virtual item type ID” is identification information on the types of virtual items for the physical items corresponding to the physical item type IDs.

The column “sales price” stores the sales prices of the types of physical items corresponding to the physical item type IDs.

### (3-4) Individual Physical Item Database 313

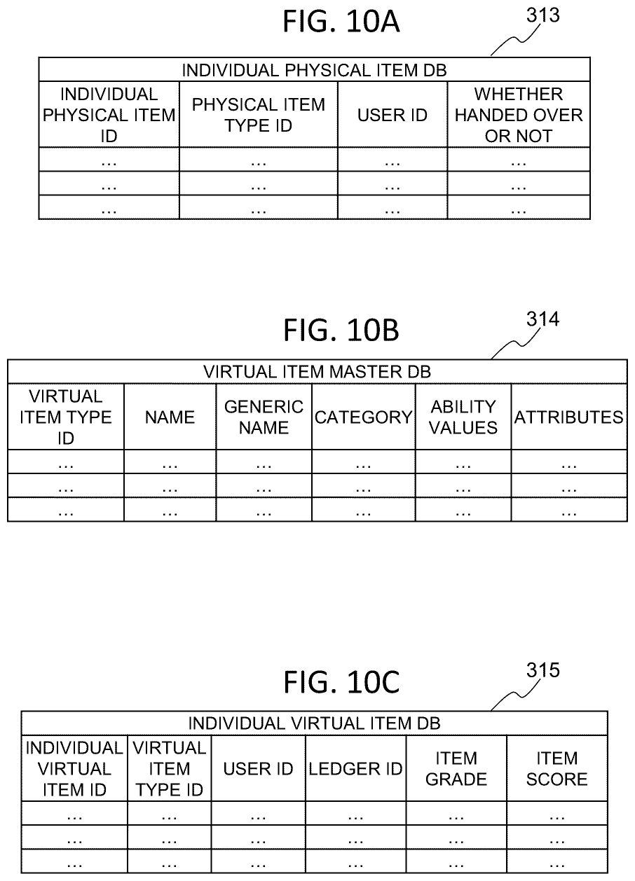

An individual physical item database (DB) 313 according to the first embodiment will be described. FIG. 10A illustrates the data structure of the individual physical item DB 313 according to the first embodiment. The individual physical item DB 313 is stored in the storage device 31 of the item management server 30.

The individual physical item DB 313 is a database that stores and manages information on each physical item (individual physical items) sold in relation to holding the event. In the individual physical item DB 313, a new record is created when a physical item is sold. The individual physical item DB 313 includes the columns “individual physical item ID,” “physical item type ID,” “user ID,” and “whether handed over or not.”

The column “individual physical item ID” stores identification information for identifying each physical item (individual physical items). Individual physical item IDs are values uniquely set for the respective physical items sold.

The column “user ID” stores identification information on the users who purchased the physical items corresponding to the individual physical item IDs.

The column “whether handed over or not” stores information indicating whether the physical items corresponding to the individual physical item IDs have been handed over.

### (3-5) Virtual Item Master Database 314

A virtual item master database (DB) 314 according to the first embodiment will be described. FIG. 10B illustrates the data structure of the virtual item master DB 314 according to the first embodiment. The virtual item master DB 314 is stored in the storage device 31 of the item management server 30.

The virtual item master DB 314 is a database that stores and manages information on the types of virtual items. In the virtual item master DB 314, a new record is created when a type of virtual items is set to be provided upon the handing over of a physical item. The virtual item master DB 314 includes the columns “virtual item type ID,” “name,” “generic name,” “category,” “ability values,” and “attributes.”

The column “virtual item type ID” stores identification information for identifying the types of virtual items. Virtual item type IDs are values uniquely set for the respective types of virtual items.

The column “name” stores the names of the types of virtual items corresponding to the virtual item type IDs.

The column “generic name” stores the common names (the generic names) of the types of virtual items corresponding to the virtual item type IDs. The common names of the virtual items may include “cap,” “towel,” “event poster,” “light stick,” and “cheering paper fan.”

The column “category” stores categories that are set according to categorization by the uses or functions of the types of virtual items corresponding to the virtual item type IDs. Examples of the categories of the virtual items include “clothes,” “souvenir,” and “cheering goods.” The categories may be set as appropriate.

The column “ability values” stores information on the abilities in the virtual space of the types of virtual items corresponding to the virtual item type IDs. Ability values may be set as appropriate according to the abilities exhibited by the virtual items in the virtual space, for example “offensive power,” “defensive power,” “cheering power,” and “appealing power.”

The column “attributes” stores information on the characteristics of the types of virtual items corresponding to the virtual item type IDs. For example, the characteristics of the virtual items may be preset according to categorization modeled on Wuxing, the Chinese doctrine of the five agents, such as the attributes “water,” “fire,” “earth,” etc.

### (3-6) Individual Virtual Item Database 315

An individual virtual item database (DB) 315 according to the first embodiment will be described. FIG. 10C illustrates the data structure of the individual virtual item DB 315 according to the first embodiment. The individual virtual item DB 315 is stored in the storage device 31 of the item management server 30.

The individual virtual item DB 315 is a database that stores and manages information on each virtual item (individual virtual items). In the individual virtual item DB 315, a new record is created when a virtual item is provided in response to the handing over of a physical item. The individual virtual item DB 315 includes the columns “individual virtual item ID,” “virtual item type ID,” “user ID,” “ledger ID,” “item grade,” and “item score.”

The column “individual virtual item ID” stores identification information for identifying each virtual item (individual virtual items). Individual virtual item IDs are values uniquely set for the respective virtual items.

The column “virtual item type ID” stores identification information on the types of the virtual items corresponding to the individual virtual item IDs.

The column “user ID” stores identification information on the users who received the virtual items corresponding to the individual virtual item IDs, that is, identification information on the initial owners.

The column “ledger ID” stores the addresses of the distributed ledgers in which owner information on the virtual items corresponding to the individual virtual item IDs is registered. The current owner of any virtual item transferred between users can be found by referring to the distributed ledger identified by the corresponding ledger ID.

The column “item grade” stores the grades of the virtual items corresponding to the individual virtual item IDs. The item grade is set based on the item score. For example, the level value increases with the score value such that the score values 0 to 200 correspond to the grade 1, and the score values 201 to 400 correspond to the grade 2.

The column “item score” stores the scores associated with the grades of the virtual items corresponding to the individual virtual item IDs.

### (3-7) Use History Database 316

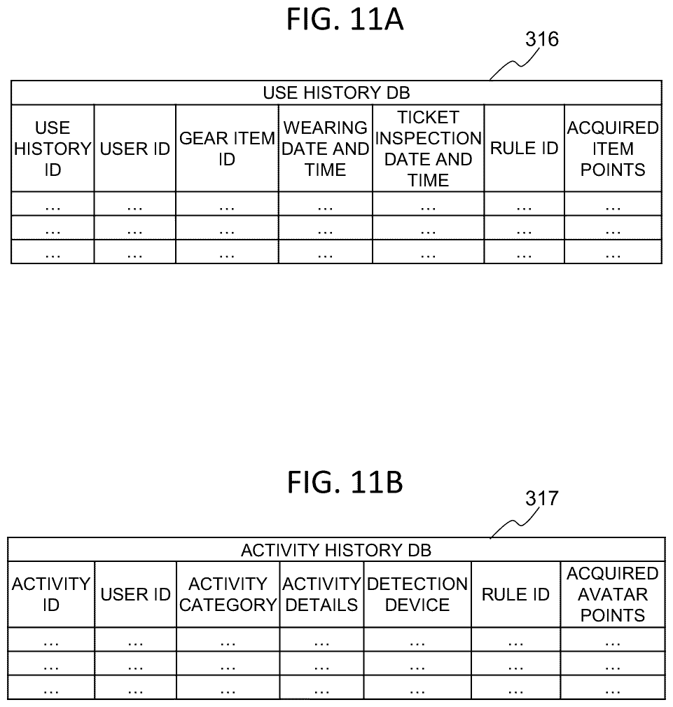

A use history database (DB) 316 according to the first embodiment will be described. FIG. 11A illustrates the data structure of the use history DB 316 according to the first embodiment. The use history DB 316 is stored in the storage device 31 of the item management server 30.

The use history DB 316 is a database that stores and manages information on the history of users' gear use. In the use history DB 316, a new record is created when a user's gear use is detected. The use history DB 316 includes the columns “use history ID,” “user ID,” “gear item ID,” “wearing date and time,” “ticket inspection date and time,” “rule ID,” and “acquired item points.”

The column “use history ID” stores identification information for identifying use history records. Use history IDs are values uniquely set for the respective use history records.

The column “user ID” stores identification information on the users involved in the use history records corresponding to the use history IDs.

The column “gear item ID” stores identification information on the gears (articles) used for the use history records corresponding to the use history IDs.

The column “wearing date and time” stores the dates and times of the registration of gear use for the use history records corresponding to the use history IDs.

The column “ticket inspection date and time” stores the dates and times of the detection of ticket inspection for the users coming to the event venue for the use history records corresponding to the use history IDs.

The column “rule ID” stores identification information on activity evaluation rules applied to give points for the use history records corresponding to the use history IDs.

The column “acquired item points” stores points of item scores acquired by the users involved in the use cases corresponding to the use history IDs.

### (3-8) Activity History Database 317

An activity history database (DB) 317 according to the first embodiment will be described. FIG. 11B illustrates the data structure of the activity history DB 317 according to the first embodiment. The activity history DB 317 is stored in the storage device 31 of the item management server 30.

The activity history DB 317 is a database that stores and manages information on the activity history of users. In the activity history DB 317, a new record is created when an activity predefined in an activity evaluation rule DB 318 is detected, among other user activities. The activity history DB 317 includes the columns “activity ID,” “user ID,” “activity category,” “activity details,” “detection device”, “rule ID,” and “acquired avatar points.”

The column “activity ID” stores identification information for identifying activities. Activity IDs are values uniquely set for the respective activities.

The column “user ID” stores identification information on the users who performed the activities corresponding to the activity IDs.

The column “activity category” stores information on the categorization of the details of the activities corresponding to the activity IDs. Activity categories include “gear use,” “gear purchase,” “noticeable cheering,” and “promotion.”

The column “activity details” stores information on the details of the activities corresponding to the activity IDs. Activity details include values such as “bring another user along.”

The column “detection device” stores information for identifying the devices that detected the activities corresponding to the activity IDs.

The column “rule ID” stores identification information on the activity evaluation rules applied to give points upon detection of the activities corresponding to the activity IDs.

The column “acquired avatar points” stores avatar points acquired by the users who performed the activities corresponding to the activity IDs.

### (3-9) Activity Evaluation Rule Database 318

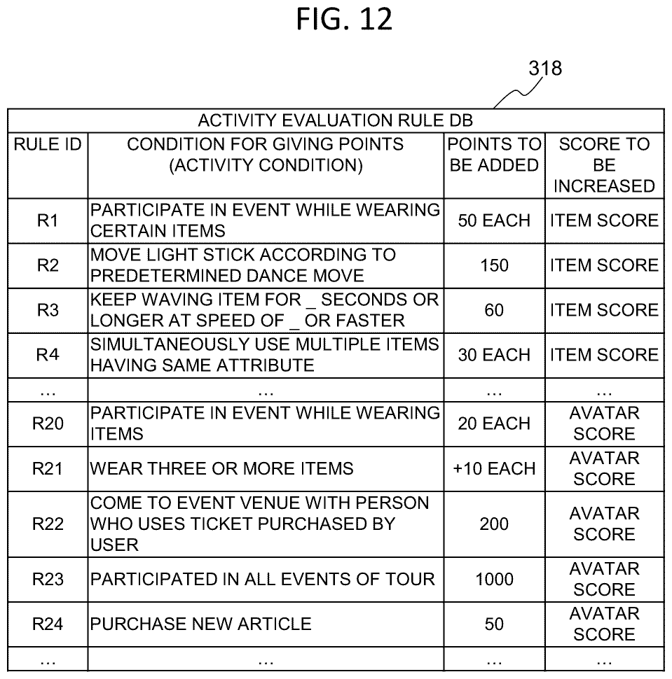

An activity evaluation rule database (DB) 318 according to the first embodiment will be described. FIG. 12 illustrates the data structure of the activity evaluation rule DB 318 according to the first embodiment. The activity evaluation rule DB 318 is stored in the storage device 31 of the item management server 30.

The activity evaluation rule DB 318 is a database that stores and manages information on rules for evaluating user activities at the event venue. In the activity evaluation DB, a new record is created when an activity that deserves points is set by the administrator. The activity evaluation rule DB 318 includes the columns “rule ID,” “condition for giving points,” “points to be given,” and “score to be increased.”

The column “rule ID” stores identification information for identifying evaluation rules. Rule IDs are values uniquely set for the respective rules.

The column “condition for giving points” stores the details of the evaluation rules corresponding to the rule IDs. Specifically, the column stores information on activity conditions indicating what user activities deserve points.

Exemplary conditions for giving points include the following.
The user participates in the event while wearing certain items.
The user moves a light stick according to a predetermined dance move.
The user keeps waving an item for _ seconds or longer at a speed of _ or faster.
The user simultaneously uses multiple items having the same attribute.
The user participates in the event while wearing items.
The user wears three or more items.
The user comes to the event venue with a person who uses a ticket purchased by the user.
The user has participated in all the events of the tour.
The user purchases a new article.

The conditions for giving points may be set by the administrator as appropriate. The set conditions are presented to the users along with the points to be given and the scores to be increased.

The column “points to be added” stores points to be given if the conditions for giving points are satisfied for the evaluation rules corresponding to the rule IDs.

The column “score to be increased” stores information that specifies scores to be increased if the conditions for giving points are satisfied for the evaluation rules corresponding to the rule IDs. Specifically, if a condition specifying “item score” is satisfied, points are added to an item score associated with an item grade. In contrast, if a condition specifying “avatar score” is satisfied, points are added to an avatar score associated with an avatar level.

### (4) Information Processing

Information processing according to the first embodiment will be described.

### (4-1) Article Sale Processing

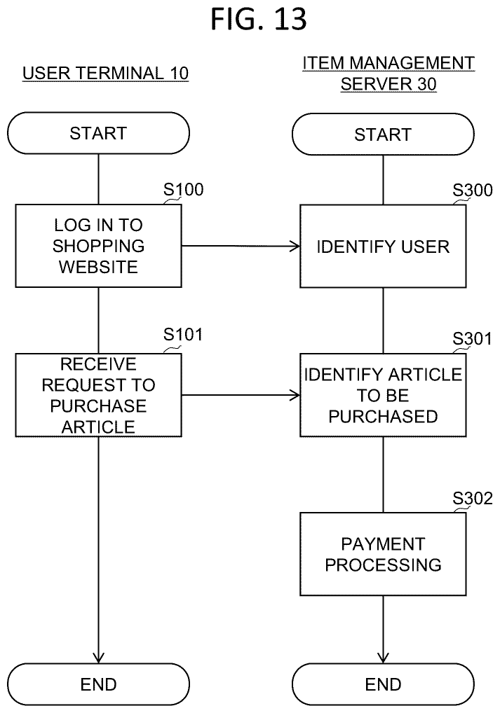

Article sale processing according to the first embodiment will be described. FIG. 13 is a flowchart of the article sale processing according to the first embodiment.

The article sale processing illustrated in FIG. 13 may start in response to a request from a user, for example. The article sale processing is performed before an event is held, for example in the user's home. It is to be noted that the article sale processing may be performed at an event venue.

As illustrated in FIG. 13, the user terminal 10 logs in to a shopping website for an article (S100).

Specifically, the user operates the user terminal 10 to input login information, which includes a user ID and a password. The user terminal 10 transmits the login information to the item management server 30.

After step S100, the item management server 30 identifies user identification information (step S300).

Specifically, the item management server 30 authenticates the login information transmitted by the user terminal 10 to permit the user's login, and transmits a webpage related to the shopping website to which the user is logging in.

After step S300, the user terminal 10 receives a request to purchase an article (step S101).

Specifically, the user terminal 10 presents purchasable articles to the user by displaying, on the display 15, the received webpage related to the shopping website. The user terminal 10 then receives an operation of the user selecting an article the user wants to purchase.

After step S101, the item management server 30 identifies the article to be purchased by the user (step S301).

Specifically, the item management server 30 obtains information on the article the user wants to purchase, received by the user terminal 10. The information on the article the user wants to purchase includes the quantity of articles the user wants to purchase.

After step S301, the item management server 30 finalizes payment using payment means (step S302).

Specifically, the item management server 30 refers to the physical item master DB 312 to determine the final payment amount. The item management server 30 may finalize the payment in cooperation with an external payment system, or by using the user's payment information stored in the user DB 311, such as credit card information. The item management server 30 creates a new record in the individual physical item DB 313.

The article sale processing thus terminates.

### (4-2) Virtual-Item Provision Processing

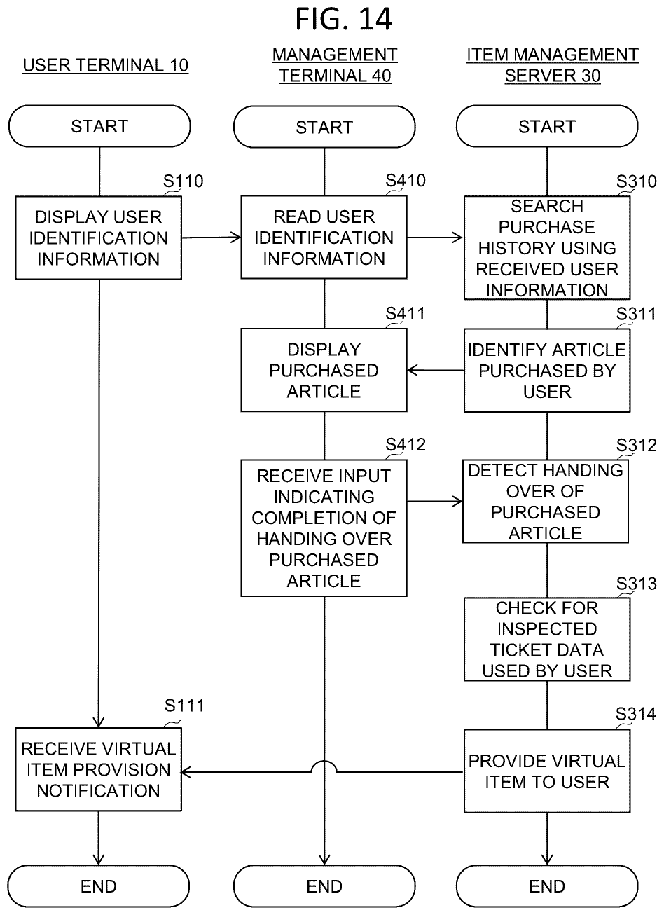

Virtual-item provision processing according to the first embodiment will be described. FIG. 14 is a flowchart of the virtual-item provision processing according to the first embodiment.

The virtual-item provision processing illustrated in FIG. 14 may start in response to a request from a user, for example. The virtual-item provision processing is performed at a place such as a merchandise booth in an event venue visited by the user. It is to be noted that the virtual-item provision processing may be performed at areas other than merchandise booths.

As illustrated in FIG. 14, the user terminal 10 displays user identification information (step S110).

Specifically, based on a request operation by the user, the user terminal 10 generates a two-dimensional code including the user identification information and displays the code on the display 15. Instead of the two-dimensional code including the user identification information, the user terminal 10 may display a one-dimensional code including the user identification information on the display. Alternatively, an RFID tag with an NFC chip may be used that resides in the user terminal 10 and stores the user identification information.

After step S110, the management terminal 40 reads the user identification information (step S410).

Specifically, the management terminal 40 reads the user identification information in the two-dimensional code by capturing, with the camera 45, the two-dimensional code displayed on the user terminal 10. The management terminal 40 transmits the read user identification information to the item management server 30.

After step S410, the item management server 30 uses the received user identification information to search purchase history (step S310).

Specifically, the item management server 30 refers to the individual physical item DB 313 to search for a record in which the user associated with the received user identification information is recorded as a purchaser.

After step S310, the item management server 30 identifies an article purchased by the user (step S311).

Specifically, the item management server 30 identifies, in the individual physical item DB 313, the type of the purchased physical item (physical item type ID) in the record in which the user is recorded as a purchaser.

After step S311, the management terminal 40 displays the purchased article (step S411).

Specifically, the management terminal 40 displays information on the identified purchased article on the display. An event staffer looks at the display screen, or an output receipt indicating the information on the display screen, to pick an article to be handed over to the user out of the stock of articles in the merchandise booth. The event staffer hands over the article to the user.

After step S411, the management terminal 40 receives input indicating the completion of handing over the purchased article (step S412).

Specifically, the event staffer who handed over the article operates the management terminal 40 to input a completion report of the completion of handing over the purchased article to the user. The management terminal 40 transmits the received completion report to the item management server 30.

After step S412, the item management server 30 detects the handing over of the article (step S312).

Specifically, the item management server 30 detects the handing over of the purchased article by receiving the report of the completion of handing over the purchased article, transmitted by the management terminal 40. At this point, the item management server 30 updates the value of “whether handed over or not” in the individual physical item DB 313 illustrated in FIG. 10A.

As illustrated in FIG. 14, after step S312, the item management server 30 checks for inspected ticket data used by the user (step S313).

Specifically, the item management server 30 refers to the ticket DB 211 stored in the ticket management server 20 and illustrated in FIG. 9A to check for a record of a ticket owned by the user who has received the article. If the record exists, the item management server 30 checks the value of “ticket inspection status.”

It is to be noted that, at step S313, the item management server 30 may only check for the event ticket, rather than checking the value of the ticket inspection status. If it is confirmed that the user has the event ticket, a virtual item may be provided to the user.

If the merchandise booth at the event venue is inside a ticket inspection area, the ticket is considered to have been inspected when the user receives the article at the merchandise booth, unless another user commits a fraud such as an imposter scam.

In contrast, if the merchandise booth at the event venue is outside the ticket inspection area, the ticket might not have been inspected when the user receives the article at the merchandise booth. In this case, the checking processing at step S313 may be repeated at predetermined time intervals within a time period (e.g., every hour during the event day). The checking processing may also be performed when the ticket is inspected.

As illustrated in FIG. 14, after step S313, the item management server 30 provides a virtual item to the user who has received the purchased article (step S314).

Specifically, if it is confirmed at step S313 that the ticket of the user who has received the article has been inspected, the item management server 30 provides a virtual item to the user. Here, the item management server 30 provides a virtual item corresponding to the article handed over to the user. The item management server 30 refers to the physical item master DB 312 illustrated in FIG. 9C to identify the virtual item to be provided. The item management server 30 creates a new record in the individual virtual item DB 315 illustrated in FIG. 10C.

The item management server 30 provides the virtual item to the user by registering information on the user as the owner of the virtual item.

Specifically, the item management server 30 causes the distributed ledger system 50 to record, in a distributed ledger and in association with the content data on the virtual item, user information (e.g., wallet information that identifies the user in the distributed ledger).

The item management server 30 records, in the cell “ledger ID” in the individual virtual item DB 315, identification information on the distribution ledger in which the information on the user has been recorded. At this point, the cells “item grade” and “item score” in the individual virtual item DB 315 are set to default values.

The item management server 30 notifies the relevant user terminal 10 that the virtual item has been provided.

As illustrated in FIG. 14, after step S314, the user terminal 10 receives the notification that the virtual item has been provided (step S111).

Specifically, the user terminal 10 receives the item provision notification transmitted by the item management server 30. The user terminal 10 presents the received item provision notification to the user by displaying the notification on the display 15.

The virtual-item provision processing thus terminates.

### (4-3) Processing of Obtaining User Gear Information

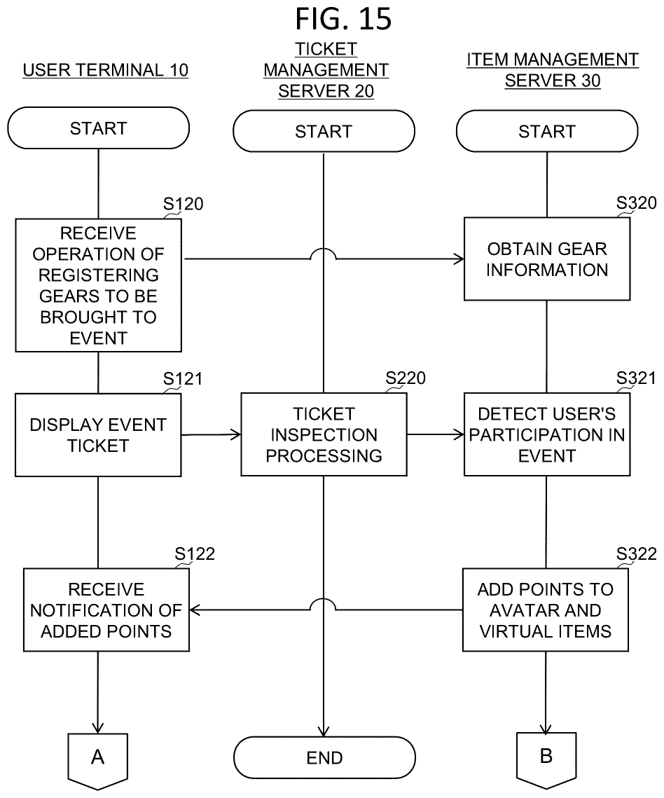

The processing of obtaining user gear information according to the first embodiment will be described. FIG. 15 is a flowchart of the processing of obtaining user gear information according to the first embodiment.

The processing of obtaining user gear information illustrated in FIG. 15 may start in response to a request from a user, for example. The processing of obtaining user gear information is performed before and after the user's arrival at an event venue.

As illustrated in FIG. 15, the user terminal 10 receives an operation of registering gears to be brought to the event (step S120).

Specifically, the user operates the user terminal 10 to register articles to be brought with the user, for example in the user's home during preparation for going to the event venue. For example, the user may be going to wear a T-shirt and a cap related to the event and carry a light stick and a towel related to the event, among other articles owned by the user. The user inputs these goods as the user's gears to the user terminal 10. The user terminal 10 transmits the received information on the gear registration operation to the item management server 30.

After step S120, the item management server 30 obtains the gear information (step S320).

Specifically, the item management server 30 receives the information on the gear registration operation transmitted by the user terminal 10. Based on the received information, the item management server 30 creates a new record in the use history DB 316 illustrated in FIG. 11A. At this point, the date and time of accepting the registration are recorded in the cell “wearing date and time” in the use history DB 316. The user then leaves for the event venue. It is to be noted that the user may register the gears at the event venue. After step S320, the user terminal 10 displays an event ticket (step S121).

Specifically, at a ticket inspection gate for regulating entrance to the event venue, the user terminal 10 responds to an operation by the user and displays, on the display 15, a two-dimensional code including information on the user's event ticket.

After step S121, ticket inspection processing is performed (step S220).

Specifically, the ticket management server 20 refers to the ticket DB 211 illustrated in FIG. 9A for the user's ticket data read by a ticket inspection terminal. If the ticket is confirmed valid, the user is allowed to enter. At this point, the ticket management server 20 updates the value of “ticket inspection status” in the ticket DB 211 to “inspected.”

As illustrated in FIG. 15, after step S220, the item management server 30 detects the user's participation in the event (step S321).

Specifically, based on the update of the value of “ticket inspection status” in the ticket DB 211 to “inspected,” the item management server 30 detects the user's participation in the event. The item management server 30 thus obtains information on the user's activity (participation in the event). The item management server 30 updates the value of “ticket inspection date and time” in the use history DB 316 illustrated in FIG. 11A.

It is to be noted that, instead of the item management server 30 checking whether the ticket has been inspected, the management terminal 40 in the event venue may read user information from the user terminal 10 to detect the user's participation in the event.

It is also to be noted that, in addition to the item management server 30 checking whether the ticket has been inspected, the management terminal 40 in the event venue may read user information from the user terminal 10 to detect the user's participation in the event.

The user's participation in the event may also be detected without checking the value of the ticket inspection status but only by checking for the event ticket and confirming that the user has the event ticket.

After step S321, the item management server 30 adds points to the avatar and virtual items as special favors given to the user in a virtual space (S322).

Specifically, the item management server 30 checks the gears of the user participating in the event and refers to the activity evaluation rule DB 318 illustrated in FIG. 12. According to rules specified in the activity evaluation rule DB 318, the item management server 30 adds points to item scores and the avatar score based on the gear items, the points to be given, and the scores to be increased.

For example, if the user wears a T-shirt and a cap and brings a light stick and a towel, at least the following points are added according to the activity evaluation rule DB 318 illustrated in FIG. 12.
according to rule R1,
   50 points to each of the item scores of the virtual items for the T-shirt, the cap, the light stick, and the towel
according to rule R20,
   80 points (20×4) to the avatar score
according to rule R21,
   40 points (10×4) to the avatar score

In the use history DB 316 illustrated in FIG. 11A, the item management server 30 records the added points in the cell “acquired item points” in the use history record for which the points are added. In the activity history DB 317 illustrated in FIG. 11B, the item management server 30 creates a new record for the user's activity for which the points are added (in this example, coming to the event venue while wearing gears). The item management server 30 transmits, to the user terminal 10, a report of the points added to the item scores and the avatar score.

After step S322, the user terminal 10 receives the notification of the added points (step S122).

Specifically, the user terminal 10 presents the received report of the added points to the user by displaying the report on the display 15.

The processing of obtaining user gear information thus terminates.

### (4-4) Processing of Obtaining User Activity Information

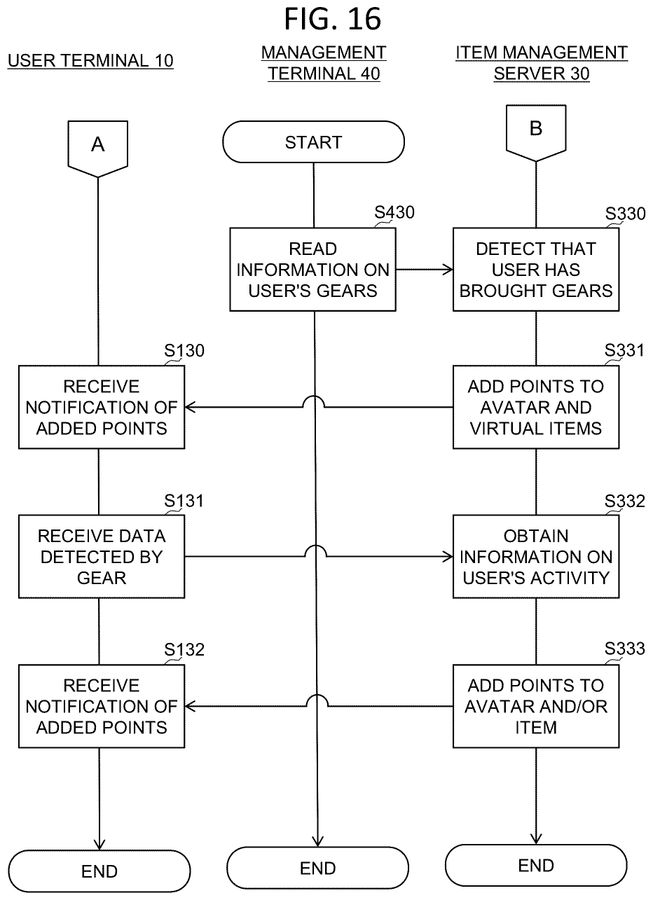

Processing of obtaining user activity information according to the first embodiment will be described. FIG. 16 is a flowchart of the processing of obtaining user activity information according to the first embodiment.

The processing of obtaining user activity information illustrated in FIG. 16 may start in response to a request from a user, for example. The processing of obtaining user activity information is performed at, for example, an event venue visited by the user. It is to be noted that the processing of obtaining user activity information may be performed at places other than the event venue.

As illustrated in FIG. 16, the management terminal 40 reads information on gears brought by the user to the event venue (step S430).

Specifically, in front of the camera 45 of the management terminal 40 disposed at a predetermined location in the event venue, the user holds, toward the camera 45, the user's identification information and a two-dimensional code attached to each gear (e.g., a light stick) brought to the event venue. The management terminal 40 thus reads the gear information.

In this manner, gears may be registered at the event venue if, for example, the user has forgotten to preregister the gears.

After step S430, the item management server 30 detects that the user has brought the gears (step S330).

Specifically, by receiving the gear information transmitted by the management terminal 40, the item management server 30 detects that the user has brought articles as gears. The item management server 30 thus obtains information on the user's gears and information on the user's activity (in this example, coming to the event venue while wearing articles) and creates a new record in the use history DB 316 illustrated in FIG. 11A.

After step S330, the item management server 30 adds points to the avatar and virtual items (step S331).

Specifically, the item management server 30 checks the gears of the user participating in the event and refers to the activity evaluation rule DB 318 illustrated in FIG. 12. The item management server 30 adds points to item scores and the avatar score based on the gear items, the points to be given, and the scores to be increased.

In the use history DB 316 illustrated in FIG. 11A, the item management server 30 records the added points in the cell “acquired item points” in the use history record for which the points are added. In the activity history DB 317 illustrated in FIG. 11B, the item management server 30 creates a new record for the user's activity for which the points are added (in this case, coming to the event venue while wearing articles).

The item management server 30 transmits, to the user terminal 10, a report of the points added to the item scores and the avatar score.

As illustrated in FIG. 16, after step S331, the user terminal 10 receives the notification of the added points (step S130).

Specifically, the user terminal 10 presents the received report of the added points to the user by displaying the report on the display 15.

The user terminal 10 further receives data detected by a gear (step S131).

Specifically, an accelerometer inside a light stick detects the acceleration of the light stick moved by the user. A processor inside the light stick wirelessly transmits the obtained sensing data to the user terminal 10 via a communication IF. The user terminal 10 receives the sensing data transmitted by the light stick, and transfers the received sensing data to the item management server 30.

The specifics of data detected by the article (the sensor type) may be set as appropriate depending on how the article is used.

After step S131, the item management server 30 obtains information on the user's activity (step S332).

Specifically, the item management server 30 obtains information on the user's activity by receiving the sensing data transferred by the user terminal 10 and analyzing the species of the sensing data. Based on the analyzed sensing data, the item management server 30 creates a new record in the activity history DB 317.

After step S332, the item management server 30 adds points to the avatar and/or a virtual item (step S333).

Specifically, the item management server 30 checks the details of the activity of the user participating in the event and refers to the activity evaluation rule DB 318 illustrated in FIG. 12. The item management server 30 determines whether the details of the activity satisfy any condition for giving points. If so, the item management server 30 adds points to the item score and/or the avatar score based on the points to be given and the scores to be increased.

For example, if the user keeps on waving the light stick for a predetermined duration or more, this activity may earn at least the following points according to the activity evaluation rule DB 318 illustrated in FIG. 12.
if the user keeps on waving the light stick for _ seconds or longer at a speed of _ or faster, then according to rule R3,
   150 points to the virtual item for the light stick

In the use history DB 316 illustrated in FIG. 11A, the item management server 30 records the added points in the cell “acquired item points” in the use history record for which the points are added. In the activity history DB 317 illustrated in FIG. 11B, the item management server 30 creates a new record for the user's activity for which the points are added (in this case, noticeable light-stick use).

The item management server 30 transmits, to the user terminal 10, a report of the points added to the item score and/or the avatar score.

After step S333, the user terminal 10 receives the notification of the added points (step S132).

Specifically, the user terminal 10 presents the received report of the added points to the user by displaying the report on the display 15.

The processing of obtaining user activity information thus terminates.

### (5) Variation

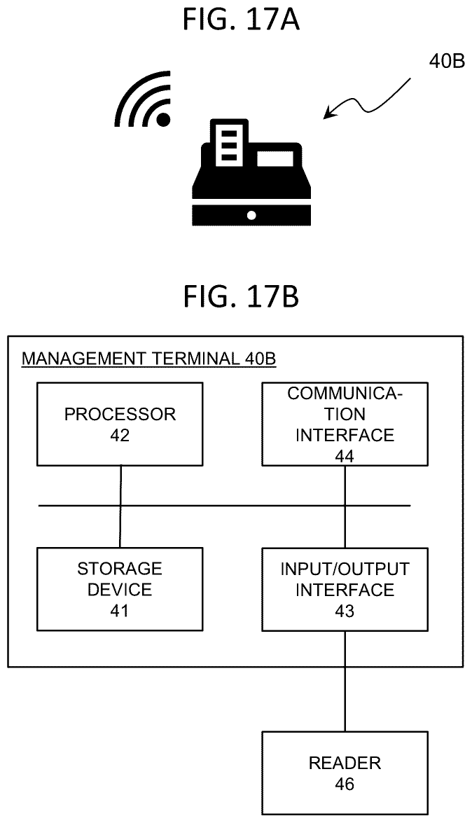

A variation of the first embodiment will now be described. FIG. 17A is a diagram illustrating a management terminal in the information processing system according to a variation. FIG. 17B is a block diagram illustrating the configuration of a management terminal 40B in the system 1 according to the variation.

### (5-1) Configuration of Management Terminal 40B

As illustrated in FIG. 17A and FIG. 17B, the management terminal 40B is a payment terminal including payment means. That is, the system 1 according to the variation is used when a user selects and purchases an article at a merchandise booth in an event venue, rather than when an article purchased by a user in advance is handed over to the user at an event venue.

The management terminal 40B includes a reader 46 instead of the camera 45. The other components, i.e., the storage device 41, the processor 42, the input/output interface, and the communication interface 44, have the same configurations as those in the above-described management terminal 40 and therefore will not be described.

The reader 46 reads a two-dimensional code including user identification information, presented by the user on the user terminal 10. The reader 46 also reads a code indicating article information, provided on, e.g., a tag attached to an article.

### (5-2) Article Sale Processing and Virtual-Item Provision Processing According to Variation

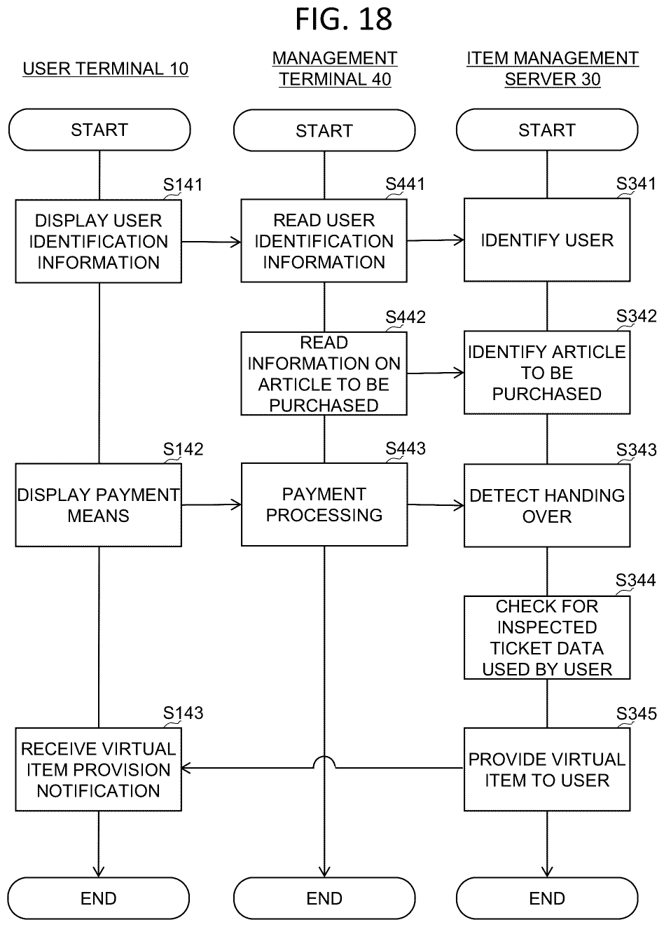

Article sale processing and virtual-item provision processing according to the variation will be described. FIG. 18 is a flowchart of the article sale processing and the virtual-item provision processing according to the variation.

The article sale processing and the virtual-item provision processing according to the variation illustrated in FIG. 18 may start in response to a request from a user, for example. The processing is performed at, for example, a merchandise booth in an event venue. It is to be noted that the virtual-item provision processing may be separately performed sometime after the event.

As illustrated in FIG. 18, the user terminal 10 displays user identification information (S141).

Specifically, based on a request operation by the user, the user terminal 10 generates a two-dimensional code including the user identification information and displays the code on the display 15.

After step S141, the management terminal 40B reads the user identification information (step S441).

Specifically, the management terminal 40B reads the user identification information in the two-dimensional code by reading, with the reader 46, the two-dimensional code displayed on the user terminal 10. The management terminal 40B transmits the read user identification information to the item management server 30. After step S441, the item management server 30 identifies the user (step S341).

Specifically, the item management server 30 identifies the user by receiving the user identification information transmitted by the management terminal 40B.

After step S341, the management terminal 40B reads information on an article to be purchased (step S442).

Specifically, the user brings an article the user wants to purchase to a cash desk at the merchandise booth and asks for the check. An event staffer operates the reader 46 of the management terminal 40B to read a two-dimensional code attached to the article. The management terminal 40B transmits the read article information to the item management server 30. Instead of the two-dimensional code attached to the article, the system may use a one-dimensional code including the article information, or an RFID tag with an NFC chip including the article information. Alternatively, a serial code associated with the article information may be provided on the article. In this case, the event staffer may input the serial code to the management terminal 40B.

After step S442, the item management server 30 identifies the article to be purchased by the user (step S342).

Specifically, the item management server 30 identifies the article to be purchased by the user by receiving the article information transmitted by the management terminal 40B. After step S342, the user terminal 10 displays payment means (step S142).

Specifically, in response to a request operation by the user, the user terminal 10 generates a two-dimensional code including the payment means and displays the code on the display 15. Here, in addition to or instead of the payment means, the user terminal 10 may generate a two-dimensional code including a member ID or biometric information and use this payment authentication information to settle a payment. Instead of the two-dimensional code, the user terminal 10 may display a one-dimensional code, including the payment means and/or the payment authentication information, on the display. Alternatively, an RFID tag with an NFC chip may be used that resides in the user terminal 10 and stores the payment means and/or the payment authentication information.

After step S142, the management terminal 40B performs payment processing (step S443).

Specifically, the management terminal 40B performs payment processing using the read payment means. The management terminal 40B provides a payment report indicating the completion of the payment processing to the item management server 30. The article is then handed over to the user.

After step S443, the item management server 30 detects the handing over of the article (step S343).

Specifically, the item management server 30 detects that the article has been sold and handed over to the user by receiving the payment report transmitted by the management terminal 40B. The item management server 30 updates the values of “user ID” and “whether handed over or not” in the record of the sold article in the individual physical item DB 313 illustrated in FIG. 10A.

After step S343, the item management server 30 checks for inspected ticket data used by the user (step S344).

Specifically, the item management server 30 refers to the ticket DB 211 stored in the ticket management server 20 and illustrated in FIG. 9A to check for a record of a ticket owned by the user having purchased the article. If the record exists, the item management server 30 checks the value of “ticket inspection status.”

After step S344, the item management server 30 provides a virtual item to the user (step S345).

Specifically, if it is confirmed at step S344 that the ticket of the user having purchased the article has been inspected, the item management server 30 provides a virtual item to the user as in the above-described processing at step S314 illustrated in FIG. 14.

That is, the item management server 30 causes the distributed ledger system 50 to record, in a distributed ledger and in association with the content data on the virtual item, user information and updates the value of “ledger ID” in the individual virtual item DB 315.

The item management server 30 notifies the relevant user terminal 10 that the virtual item has been provided.

As illustrated in FIG. 18, after step S345, the user terminal 10 receives the notification that the virtual item has been provided (step S143).

Specifically, the user terminal 10 receives the item provision notification transmitted by the item management server 30. The user terminal 10 presents the received item provision notification to the user by displaying the notification on the display 15.

The article sale processing and the virtual-item provision processing according to the variation thus terminate.

### (6) Brief Summary

As described above, according to the system 1 in this embodiment, a virtual item can be provided as a special favor to a user who has received, at an event venue, an event-related article purchased by the user. This can stimulate the user's desire to collect virtual items, motivate the user to go to the event venue, and promote the sales of event-related articles.

The system 1 provides a virtual item to the user after confirming that the user's ticket data has been inspected. This can effectively prevent an imposter scam, for example a case in which the user does not go to the event venue and only provides user identification information to a third person, who then receives a virtual item. Thus, providing a virtual item can appropriately motivate participation in the event.

The system 1 identifies the user by reading user information from the user terminal 10. This can prevent an imposter scam by a third person.

The system 1 provides, to the user, a virtual item corresponding to an article purchased by the user. This allows the user to obtain a virtual item corresponding to a real item purchased by the user, thereby arousing the user's desire to purchase articles.

The system 1 identifies an article purchased by the user based on purchase history indicating purchases made by the user. This can eliminate the need for payment processing at a merchandise booth in the event venue, thereby streamlining the event operation.

The system 1 may read article information attached to an article purchased by the user. This allows appropriately identifying an article purchased on the spot at the event venue.

The system 1 provides a virtual item to the user by registering user information; the virtual item is provided as a non-fungible token capable of having virtual-item owner information registered. This clarifies the owner of the virtual item, which is digital content, thereby allowing the virtual item to be transferred between users. That is, a virtual item as a special favor goes beyond a mere collectable item for an individual user and becomes an item having an asset value, tradable with other users. This can more effectively motivate the user to go to the event venue in order to obtain virtual items.

In the system 1, the management terminal 40 transmits the read user information to the item management server 30. This can facilitate the virtual-item provision processing in handing over an article at the event venue.

In the system 1, the management terminal 40 serving as a payment terminal transmits the read user information and article information to the item management server 30. This can facilitate the virtual-item provision processing in handing over an article sold at the event venue.

The system 1 adds points to the user's account and virtual items as special favors in a virtual space, depending on the user's gears in participating in the event and depending on the user's activities at the event venue. This can motivate the user who purchased articles to bring the articles as gears to the event venue, encouraging the user to use event-related articles at the event venue.

The system 1 detects, as the user's activity, the user's participation in the event. This can prompt the user to participate in the event while wearing articles owned by the user.

The system 1 detects the user's participation in the event based on ticket inspection upon the user's entrance to the event venue. This can effectively prevent an imposter scam by a third person and appropriately prompt the user to use articles at the event venue.

The system 1 may also detect the user's participation in the event by reading user information from the user terminal 10 in the event venue. The system 1 can then accurately confirm the user's participation in the event because the user's actual presence at the event venue is evident.

The system 1 adds points to a virtual item corresponding to a gear used by the user, depending on the manner in which the user uses the gear in the event venue. The administrator may set and present, to the user in advance, the manners of gear use that deserve points. This can prompt the user to perform desired activities that contribute to enlivening the event.

The system 1 reads gear information from a gear brought by the user in the event venue and adds points to a virtual item corresponding to the gear. This can give an opportunity for a user who has forgotten to preregister a gear to smoothly register the gear at the event venue.

The system 1 detects the user's purchase of new gears in the event venue and adds points to the user's account depending on the degree of the gear purchase. This can prompt the user to purchase new articles.

The system 1 detects the quantities of gears brought by the user to the event venue and adds points to the user's account depending on the quantities of the gears brought to the event venue. This can prompt more active use of articles by the user.

As the level of the user's account rises with addition of points to the user, the system 1 presents choices selectable by the user to change, as the user desires, the appearance of an avatar usable by the account. Thus, a user who wants to change the appearance of the avatar to suit the user's preference can be motivated to acquire points.

As the grade of a virtual item rises with addition of points to the virtual item, the system 1 restyles the appearance of the virtual item. Continuously acquiring points to a virtual item increases the added value of the virtual item, which is a non-fungible token, thereby increasing the asset value of the virtual item as an item tradable with users.

This can provide a novel personal profit model. That is, actively using a user's article as a gear at an event venue to cheer an artist or the like has conventionally been a mere leisure activity of fans. Such an activity is now a form of asset management that contributes to the user's asset formation.

### Second Embodiment

A second embodiment of the present invention will now be described in detail with reference to the drawings. Throughout the drawings for describing the embodiment, like elements are generally given like symbols and will not be repeatedly described.

### (7) Configuration of Information Processing System 2

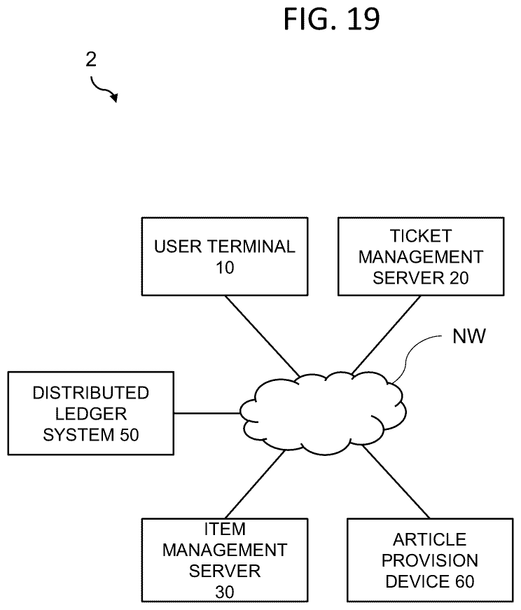

The configuration of an information processing system 2 (which may hereinafter simply be referred to as a system 2) according to this embodiment will be described. FIG. 19 is a block diagram illustrating the configuration of the information processing system 2 according to the second embodiment.

As illustrated in FIG. 19, instead of the management terminal 40 according to the first embodiment, the system 2 includes an article provision device 60. The article provision device 60 is disposed at any location in the premises of an event venue, such as a merchandise booth in the event venue, during the event period. The article provision device 60 is a vending machine that automatically provides articles to users at their request without intervention of event staff.

The article provision device 60 is communicatively connected to the user terminal 10, the ticket management server 20, the item management server 30, and the distributed ledger system 50 via the network NW.

The other components of the information processing system 2 are the same as those in the first embodiment and therefore will not be described.

### (7-1) Configuration of Article Provision Device 60

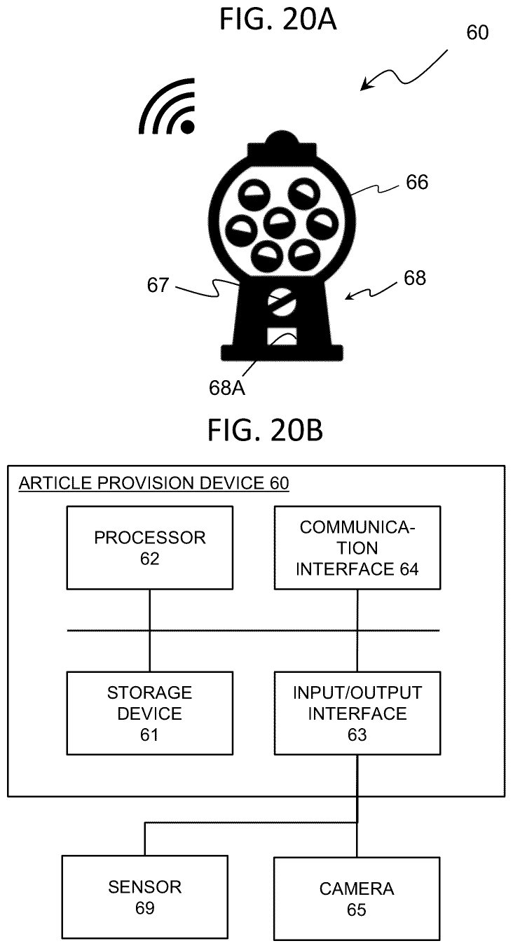

The configuration of the article provision device 60 will be described. FIG. 20A is an article provision device. FIG. 20B is a block diagram illustrating the configuration of the article provision device 60.

As illustrated in FIG. 20A and FIG. 20B, the article provision device 60 includes a storage device 61, a processor 62, an input/output interface 63, a communication interface 64, a camera 65, a container 66, an operation part 67, an ejection mechanism 68, and a sensor 69.

The storage device 61 is configured to store programs and data. The storage device 61 is, for example, a combination of ROM, RAM, and storage (e.g., a flash memory or a hard disk).

Examples of the programs include the following.
programs of an OS
programs of applications (e.g., a web browser) that perform information processing

Examples of the data include the following.
databases referred to in information processing
data resulting from performing information processing (i.e., results of performing information processing)

The processor 62 is a computer that implements the functions of the article provision device 60 by executing programs stored in the storage device 61. The processor 62 is, for example, at least one of the following.
a CPU
a GPU
an ASIC
an FPGA

The input/output interface 63 is configured to obtain information (e.g., a user instruction) from an input device connected to the article provision device 60 and to output information (e.g., an image) to an output device connected to the article provision device 60.

The input device is, for example, a keyboard, a pointing device, a touch panel, or a combination thereof.

The output device is, for example, a display, a speaker, or a combination thereof.

The communication interface 64 is configured to control communication between the article provision device 60 and external devices (e.g., the user terminal 10, the ticket management server 20, the item management server 30, or the distributed ledger system 50).

The camera 645 inputs, to the input/output interface 63, image data obtained with an imaging module.

The container 66 is a case that stores a plurality of types of articles. In the example shown, the container 66 is formed of a transparent material and stores capsules each containing an article. It is to be noted that the container 66 is not limited to such a configuration. Articles need not to be encapsulated.

The operation part 67 is a member operated by a user upon completion of payment for article provision. In the example shown, the operation part 67 is a handle member disposed below the container 66, and is rotated by the user's operation about a horizontal axis extending in the anterior-posterior direction. It is to be noted that the operation part 67 is not limited to such a configuration.

The ejection mechanism 68 ejects, from the container 66 to the outside, at least one of the articles in the container 66 chosen without user selection, in response to the user's operation on the operation part 67. In the example shown, a blocking plate (not shown) disposed in the container 66 blocks an ejection path 68A; in response to the user's operation of rotating the operation part 67, the ejection mechanism 68 rotates the blocking plate about a vertical axis. When an opening in the blocking plate aligns with the ejection path 68A, one of the capsules in the container 66 is ejected. It is to be noted that the ejection mechanism 68 is not limited to such a configuration. For example, the ejection mechanism 68 may eject multiple articles in response to one operation.

The sensor 69 senses an article to be provided to the user. The sensor 69 reads information on an article while the article is being ejected from the container 66 toward the outside.

In the example shown, the sensor 69 is a short-range wireless sensor. The capsules containing articles each have a wireless communication tag attached thereto. When a capsule is ejected from the container 66 toward the outside, the sensor 69 wirelessly communicates with the wireless communication tag (an RFID tag) on the capsule to read information on the article therein. For example, the sensor 69 is disposed to be capable of sensing inside the ejection path 68A, so that it detects a tag on a capsule being ejected from the container 66 through the ejection path toward the outside.

### (8) Information Processing

Information processing according to the second embodiment will be described.

### (8-1) Article Sale Processing According to Second Embodiment

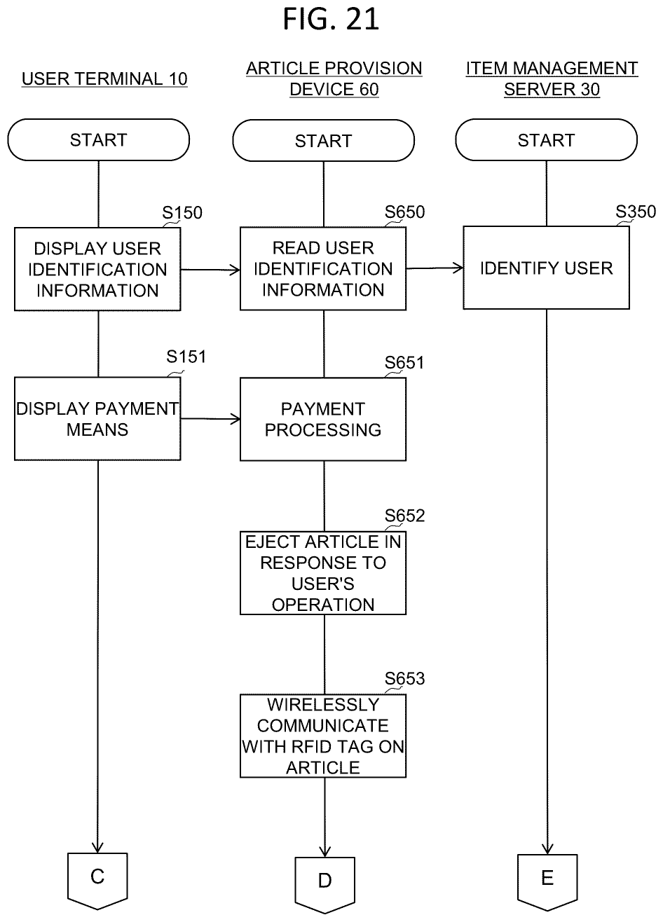

Article sale processing according to the second embodiment will be described. FIG. 21 is a flowchart of the article sale processing according to the second embodiment.

The article sale processing illustrated in FIG. 21 may start in response to a request from a user, for example. The article sale processing is performed at a merchandise booth in an event venue visited by the user.

As illustrated in FIG. 21, the user terminal 10 displays user identification information (step S150).

Specifically, based on a request operation by the user, the user terminal 10 generates a two-dimensional code including the user identification information and displays the code on the display 15.

After step S150, the article provision device 60 reads the user identification information (step S650).

Specifically, the article provision device 60 reads the user identification information in the two-dimensional code by capturing, with the camera 45, the two-dimensional code displayed on the user terminal 10. The article provision device 60 transmits the read user identification information to the item management server 30.

After step S650, the item management server 30 identifies the user (step S350).

Specifically, the item management server 30 identifies the user by receiving the user identification information transmitted by the article provision device 60. After step S350, the user terminal 10 displays payment means (step S151).

Specifically, in response to a request operation by the user, the user terminal 10 generates a two-dimensional code including the payment means and displays the code on the display 15.

After step S151, the article provision device 60 performs payment processing (step S651).

Specifically, the article provision device 60 performs payment processing using the read payment means. On condition that the payment is settled, the article provision device 60 makes the operation part 67 operable by the user.

After step S651, the article provision device 60 ejects an article in response to the user's operation (step S652).

Specifically, in response to the user's operation of rotating the operation part 67, the article provision device 60 drives the ejection mechanism 68 to eject one of the capsules in the container 66. Here, the capsule is randomly chosen without user selection in a manner that depends mainly on the positions of the capsules in the container 66.

In the process of step S652, the article provision device 60 wirelessly communicates with an RFID tag on the article (step S653).

Specifically, the sensor 69 of the article provision device 60 detects the tag on the capsule being ejected from the container 66 through the ejection path 68A toward the outside. The article provision device 60 thus obtains information on the article being ejected. The capsule is ejected through the ejection path 68A and the article is provided to the user.

The article sale processing according to this embodiment thus terminates.

### (8-2) Virtual-Item Provision Processing According to Second Embodiment

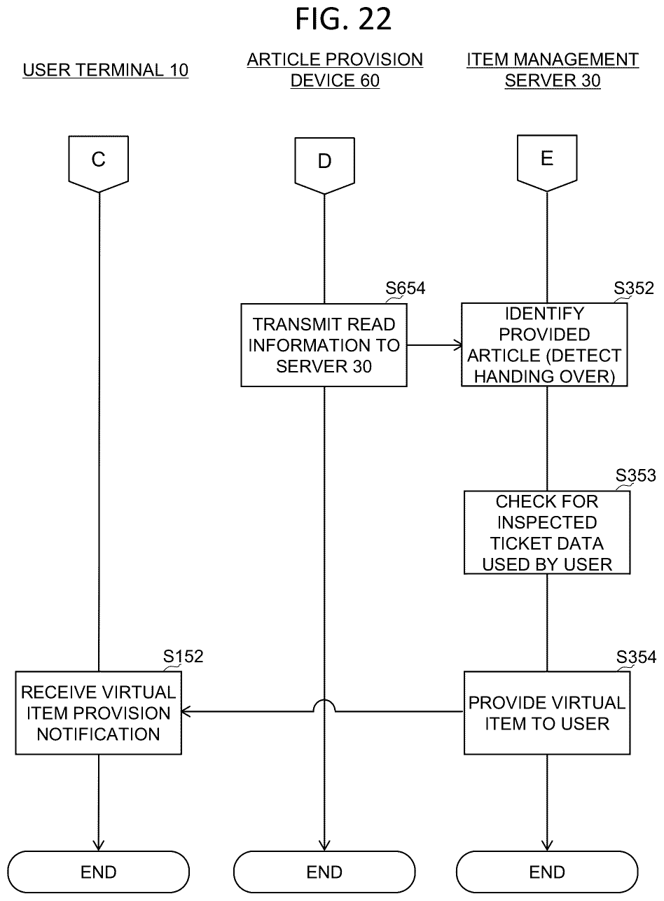

Virtual-item provision processing according to the second embodiment will be described. FIG. 22 is a flowchart of the virtual-item provision processing according to the second embodiment.

The virtual-item provision processing illustrated in FIG. 22 may start following the above-described article sale processing according to this embodiment. The virtual-item provision processing is performed at a merchandise booth in an event venue visited by a user. It is to be noted that the virtual-item provision processing may be performed sometime later.

As illustrated in FIG. 22, the article provision device 60 transmits the read article information to the item management server 30 (step S654).

Specifically, the article provision device 60 transmits, to the item management server 30, the information read by the sensor 69 on the article provided to the user.

After step S654, the item management server 30 identifies the article provided to the user (step S352).

Specifically, the item management server 30 identifies the article provided to the user by receiving the information transmitted by the article provision device 60 on the article provided to the user. The item management server 30 thus detects the handing over of the article. The item management server 30 updates the values of “user ID” and “whether handed over or not” in the record of the sold article in the individual physical item DB 313 illustrated in FIG. 10A.

After step S352, the item management server 30 checks for inspected ticket data used by the user (step S353).

Specifically, the item management server 30 refers to the ticket DB 211 stored in the ticket management server 20 and illustrated in FIG. 9A to check for a record of a ticket owned by the user having purchased the article. If the record exists, the item management server 30 checks the value of “ticket inspection status.”

After step S353, the item management server 30 provides a virtual item to the user (step S354).

Specifically, if it is confirmed at step S652 illustrated in FIG. 21 that the ticket of the user who has received the article has been inspected, the item management server 30 provides a virtual item to the user as in the above-described processing at step S314 illustrated in FIG. 14.

That is, the item management server 30 causes the distributed ledger system 50 to record, in a distributed ledger and in association with the content data on the virtual item, user information and updates the value of “ledger ID” in the individual virtual item DB 315.

The item management server 30 notifies the relevant user terminal 10 that the virtual item has been provided.

As illustrated in FIG. 22, after step S354, the user terminal 10 receives the notification that the virtual item has been provided (step S152).

Specifically, the user terminal 10 receives the item provision notification transmitted by the item management server 30. The user terminal 10 presents the received item provision notification to the user by displaying the notification on the display 15.

The virtual-item provision processing according to the second embodiment thus terminates.

### (9) Brief Summary

As described above, according to the system 2 in this embodiment, the article provision device 60 provides any of the articles in the container to the user in response to the user's operation on the operation part 67 after the completion of payment for article provision. The article provision device 60 transmits the read user information and article information to the item management server 30. This can facilitate the virtual-item provision processing in automatic article sale.

The article provision device 60 provides, to the user, at least one article chosen without user selection. The user therefore cannot always purchase a user-desired article. This can stir up the user's speculative spirit for collecting rare articles, thereby arousing the user's desire to purchase.

In the article provision device 60, the sensor 69 reads information on an article being ejected from the container 66 toward the outside. Thus, information on an article automatically sold and handed over without event-staff intervention can be accurately obtained.

In the article provision device 60, the sensor 69 reads information on an article being ejected from the container 66 toward the outside by wirelessly communicating with a wireless communication tag on the article. This allows accurately sensing the article.

### (10) Other Variations

The storage device 11 may be connected to the user terminal 10 via the network NW. The display 15 may be included in the user terminal 10. The storage device 21 may be connected to the ticket management server 20 via the network NW. The storage device 31 may be connected to the item management server 30 via the network NW. The storage device 41 may be connected to the management terminal 40 via the network NW. The storage device 61 may be connected to the article provision device 60 via the network NW.

The steps of the above-described information processing may be performed by either the user terminal 10 or the item management server 30. The order of the steps of the above-described information processing may be changed as long as the processing maintains consistency.

Although the above description focuses on an event, what the systems 1 and 2 manage are not limited to events such as functions and shows. The systems 1 and 2 are applicable to any service that satisfies the following requirements.
The target of the service is based on a specific concept (hereinafter referred to as a target concept) involving fans.
The service is provided in a specific area.
Articles related to the target concept are sold in the specific area.

Other services satisfying the above conditions include movie houses, art museums, other museums, theaters, amusement parks, transportation facilities, restaurants, and brand-name stores.

More preferably, what the systems 1 and 2 manage satisfy the following condition.
Tickets are issued as certificates of payment for receiving the service.

In the above-described processing, the systems 1 and 2 add points to both the virtual item(s) and the avatar. However, this is not limiting. The systems 1 and 2 may only add points to either the virtual item(s) or the avatar.

The systems 1 and 2 may obtain information on the user's activity in the following exemplary manners.
The systems detect the user's activity with a camera disposed in the event venue to determine whether the user is moving according to a predetermined dance move.
The systems determine whether the user is bringing a companion with the user based on the history of ticket data transferred from the user to another user, and based on the proximity of the user's ticket inspection time to the ticket inspection time of the other user having the transferred ticket data.
The systems detect the user's purchase of a new article based on article purchase history.
The systems detect the completion of participating in all the events of a concert tour based on the ticket inspection statuses of other pieces of ticket data owned by the user.
The systems detect whether the user is carrying a physical item (such as a light stick or a cap) with the user (whether the physical item is always near the user while the user is traveling) based on: a sensor provided in the physical item (such as an accelerometer, a gyro sensor, an infrared sensor, an electrostatic sensor, an image sensor, a ranging sensor, a physical button, a pressure sensor, or a temperature sensor); location information obtained by the user terminal 10; and short-range wireless communication between the physical item and the user terminal 10.
The systems detect whether a predetermined operation (such as a tap, a gesture, or a press on a button) is performed on a physical item (such as a light stick or an electronic terminal) and on the screen or a button of the user terminal 10.
The systems detect, as the user's activity, the location of a physical item estimated by short-range wireless communication between the physical item and a user terminal capable of obtaining location information.
The systems detect, as the user's activity, the location of a physical item estimated from location information obtained by the physical item.
The systems detect the user's activity based on predetermined input (voice input/operation input) by the user to a physical item.
The systems detect the user's activity based on the user using a physical item to provide predetermined input to a predetermined terminal disposed in the event venue (capturing an image with the predetermined terminal).

In the systems 1 and 2, the gear information may be automatically obtained, and the user activity information may be obtained based on the user's own declaration.

Exemplary conditions for giving points according to the activity evaluation rule DB 318 in the systems 1 and 2 include the following, in addition to the above-described conditions.
Multiple users (a user group) entering at close times (such as within several minutes) all purchase articles.
The user flashes a light stick according to the event organizer's instruction.
The user stays near the event venue more than a predetermined time before the opening of the event venue.
The user wins a lottery held at the event venue (including one held in the system).

Upon the user's winning the lottery, the system may control the behavior of the user's physical item (e.g., cause a light stick to flash) for effect.
The user enters a predetermined area at a predetermined time, or stays at a predetermined area for a predetermined duration. (In a music event such as a music festival with multiple artists, the user may stay in an area near the stage of a particular artist's performance for more than a predetermined duration during the artist's performing time. This may be detected from location information obtained by the user terminal 10 or from area-wise ticket inspection.)
The user has the user's ticket inspected earlier than a predetermined time (this is evaluated as an activity that exhibits a feeling of anticipation for the event).
The user participates in the event with a companion (this may be determined based on the fact that they use electronic tickets in the same ticket book having specific identification information, or that the companion is a preregistered companion, or that they simultaneously enter the same area in a virtual space where a virtual event is being held).
The user purchases a special ticket such as a VIP seat ticket, or enters the venue using the special ticket.
The user yells a particular word, or makes sound at higher than a predetermined volume level, according to the event organizer's instruction.
The user waves a light stick or beats a terminal according to the event organizer's instruction or according to a rhythm.

The special favors in the virtual space provided by the systems 1 and 2 depending on the user's activities are not limited to points to the avatar and virtual items. For example, the systems 1 and 2 may provide a further virtual item (a special item) to the user if the user's activity satisfies a condition for giving points in the activity evaluation rule DB 318. Exemplary conditions for providing a further virtual item may include the following.
A special virtual item is provided if a combination of articles simultaneously purchased by the user satisfies a predetermined condition.
A special virtual item is provided if the user purchases all of mutually related different articles (articles of different colors, or a certain set of articles) or the like.
A special virtual item is provided if the user comes to the venue with a predetermined number or more of new participants.
A special virtual item is provided if the user comes to every event of a concert tour with a companion.

The systems 1 and 2 in the above description set an individual item score for each virtual item. Alternatively, the systems 1 and 2 may set an item score for each group of virtual items belonging to the same generic name or the same category.

For example, if an item score is set for each group of virtual items belonging to the same generic name, a common item score is set for the different light-stick virtual items belonging to the generic name “light stick.” If an item score is set for each group of virtual items belonging to the same category, a common item score is set for the different virtual items belonging to the category “cheering goods.”

The above description illustrates the case in which the sensor 69 of the article provision device 60 is a short-range wireless sensor that wirelessly communicates with wireless communication tags on articles. However, this is not limiting.

Exemplary manners in which the article provision device 60 reads information on an article to be provided include the following.
image recognition (for the color or content of the capsule)
reading a two-dimensional code
the weight of the capsule ejected
ultrasound-based sensing

It is to be noted that the article provision device 60 may employ detection manners other than the above to read information of an article to be provided.

The payment means used for the payment processing involves the following modes.
settling the payment by causing the terminal to read the user's two-dimensional payment code in a payment application (as in the above embodiments)
displaying a two-dimensional code, including a user ID and payment means, and causing the terminal to simultaneously identify the user and the payment means
causing the terminal to read a two-dimensional code indicating a user ID, and settling the payment using payment means, such as credit card information, included in account information associated with the user ID

That is, some payment methods can eliminate the need to display the payment means.

Instead of the two-dimensional payment code, the system may use, as the payment means, a one-dimensional payment code, a payment RFID tag including an NFC chip, or payment biometric information, to perform the payment processing.

The article provision device 60 does not necessarily have to randomly choose an article from the container 66. For example, articles may be provided in a preset order from the article provision device 60. This can eliminate the need to sense the article being provided by the article provision device 60, leading to a simply structured article provision device 60.

The article provision device 60 may be a lottery system implemented in the system.

For example, triggered by ticket inspection for the user coming to the venue, a gacha serving as a lottery system receives an application for a lottery from the user's user terminal. The user draws a lot, and a preset image of a voucher for an article is displayed on the user terminal.

The user causes the management terminal 40 to read a two-dimensional code in the voucher image. This identifies the article to be provided to the user, and an event staffer hands over the article to the user.

In response to detecting the handing over of the article, a virtual item is provided to the user.

In such a case, the article provision device 60 may eject a card on which a two-dimensional code indicating an article to be provided to the user is printed. The user terminal 10 or the management terminal 40 may read the two-dimensional code on the card to detect user information and the handing over of the article.

Each physical item may have an individual registration code thereon. Based on the registration code input to the user terminal 10, behaviors of a virtual item in the virtual space may be synchronized with behaviors of the physical item in the real space.

The ability of a virtual item contemplated in the present invention may be changed or maintained; the ability change may be triggered by transfer of the virtual item between users (secondary distribution). That is, secondary distribution of a virtual item may disable the ability of the virtual item.

The ability of a virtual item may be set to be advantageous or disadvantageous for the initial owner of the virtual item. The first owner of a virtual item may be given a special favor related to the virtual item.

The user may acquire predetermined ones of virtual items contemplated in the present invention, which may be integrated into a virtual integrated item, increasing the level of virtual item. The user acquiring such an integrated item may receive a real item as a special favor.

The user coming to the event with a person the user took to a past event may receive a special favor, such as a bonus. For example, if the user participates in the event with a person the user took to a past event, more points than usual may be given to the user as a bonus.

If multiple users registered as companions wear the same gear, these users may each receive a special item.

If the user registers, as a companion, a new user who has never participated in the event, and comes to the event with the new participant, the user may receive a special item for contribution to enlivening the event.

The scores may be considered experience points; if the experience points exceed a threshold, the level may rise.

Virtual items may be restricted to the use only in specific areas in the virtual space, depending on their preset attributes.

Instead of the avatar level, the level of the account of the user who uses the avatar may be managed. That is, if one account uses multiple avatars, the user's account level applies to all the avatars. In this case, points are given to the account.

While embodiments of the present invention have been described in detail above, the scope of the present invention should not be limited to the above embodiments. Various improvements and modifications may be made to the above embodiments within the spirit of the present invention. Combinations of the above embodiments and variations are also possible.

The following is a supplement to aspects of the above embodiments.

### Supplementary Item 1

An apparatus comprising circuitry configured to:
obtain, from a user, information on a gear of the user in participating in an event held in a real space;
obtain information on an activity of the user in the event; and
provide, depending on the obtained information on the activity of the user, a special favor in a virtual space to the user.

### Supplementary Item 2

The apparatus according to supplementary item 1, wherein the circuitry is configured to, if the activity of the user satisfies a predetermined condition, add points to at least one of: an account identifying the user in the virtual space; and a virtual item corresponding to the gear and usable by the user in the virtual space.

### Supplementary Item 3

The apparatus according to supplementary item 1, wherein the circuitry is configured to detect the user's participation in the event by confirming that the user has ticket data necessary for participating in the event.

### Supplementary Item 4

The apparatus according to supplementary item 3, wherein the circuitry is configured to detect the user's participation in the event by confirming that the user has the ticket data and that the ticket data has been inspected upon the user's entrance to an event venue.

### Supplementary Item 5

The apparatus according to supplementary item 4, wherein the circuitry is configured to detect the user's participation in the event by reading information on the user from a user terminal used by the user in the event venue.

### Supplementary Item 6

The apparatus according to supplementary item 2, wherein the circuitry is configured to:
detect, as the activity of the user, the manner of use of the gear by the user in an event venue, and
add points, depending on the degree of the detected manner of use of the gear, to the virtual item corresponding to the gear used.

### Supplementary Item 7

The apparatus according to supplementary item 2, wherein the circuitry is configured to:
detect, by reading information on the gear from the gear in an event venue, that the user has brought the gear, and
add points to the virtual item corresponding to the gear brought by the user.

### Supplementary Item 8

The apparatus according to supplementary item 2, wherein the circuitry is configured to:
detect purchase of a new gear by the user in an event venue, and
add points to the account depending on the degree of the purchase of the gear.

### Supplementary Item 9

The apparatus according to supplementary item 2, wherein the circuitry is configured to:
detect the quantity of gears brought by the user to an event venue, and
add points to the account depending on the quantity of the gears brought to the event venue.

### Supplementary Item 10

The apparatus according to supplementary item 2, wherein the circuitry is configured to, as the level of the account rises with addition of points to the user, present choices selectable by the user to change, as the user desires, the appearance of an avatar usable by the account.

### Supplementary Item 11

The apparatus according to supplementary item 2, wherein the circuitry is configured to, as the grade of the virtual item rises with addition of points to the virtual item, restyle the appearance of the virtual item.

### Supplementary Item 12

A method for operating a computer comprising circuitry, wherein the circuitry executes:
obtaining, from a user, information on a gear of the user in participating in an event held in a real space;
obtaining information on an activity of the user in the event; and
providing, depending on the obtained activity of the user, a special favor in a virtual space to the user.

### Supplementary Item 13

A system comprising circuitry configured to:
obtain, from a user, information on a gear of the user in participating in an event held in a real space;
obtain information on an activity of the user in the event; and
   provide, depending on the obtained activity of the user, a special favor in a virtual space to the user.

1. An apparatus comprising circuitry configured to:
identify a user;
detect that an article purchased by the user and related to an event held in a real space is handed over to the user at an event venue; and
provide a virtual item usable in a virtual space to the user who has received the article.

2. The apparatus according to claim 1, wherein the circuitry is configured to provide the virtual item to the user after confirming that the user has ticket data necessary for participating in the event.

3. The apparatus according to claim 2, wherein the circuitry is configured to provide the virtual item to the user after confirming that the user has the ticket data and that the ticket data has been inspected.

4. The apparatus according to claim 3, wherein the circuitry is configured to identify the user by reading information on the user from a user terminal used by the user.

5. The apparatus according to claim 1, wherein the circuitry is configured to:
identify the article purchased by the user, and;
provide, to the user, a virtual item corresponding to the article purchased by the user.

6. The apparatus according to claim 5, wherein the circuitry is configured to identify the article purchased by the user by reading information on the article, the information attached to the article purchased by the user.

7. The apparatus according to claim 5, wherein the circuitry is configured to identify the article purchased by the user based on purchase history indicating a purchase made by the user.

8. The apparatus according to claim 1, wherein the circuitry is configured to provide the virtual item to the user by registering information on the user on a non-fungible token configured to allow virtual-item owner information.

9. A method for operating a computer comprising circuitry, wherein the circuitry executes:
identifying a user;
detecting that an article purchased by the user and related to an event held in a real space is handed over to the user at an event venue; and
providing a virtual item usable in a virtual space to the user who has received the article.

10. A system comprising a provision apparatus comprising circuitry configured to:
identify a user;
detect that an article purchased by the user and related to an event held in a real space is handed over to the user at an event venue; and
provide a virtual item usable in a virtual space to the user who has received the article.

11. The system comprising according to claim 10, the system comprising a transmission apparatus comprising circuitry configured to:
settle payment for purchase of an article;
read information on a user purchasing the article;
read information on the article, the information attached to the article; and
transmit, to the provision apparatus, the read information on the user and the read information on the article.

12. The system comprising according to claim 10, the system comprising a display apparatus comprising circuitry configured to:
read information on a user;
transmit, to the provision apparatus, the read information on the user; and
display information on an article purchased by the user, the information being provided by the provision apparatus.

13. The system comprising according to claim 10, the system comprising an article provision apparatus comprising:
circuitry configured to:
read information on a user who is to receive an article; and
settle payment for provision of the article,
a container configured to store a plurality of types of articles;
an operation part configured to accept operations according to the payment;
an ejection mechanism configured to provide, in response to an operation on the operation part, at least one of the articles in the container chosen without user selection to the user by ejecting the at least one article from the container to outside, wherein
the circuitry is configured to read information on the article to be provided to the user and transmit, to the provision apparatus, the read information on the user and the read information on the article.

14. The system comprising according to claim 13, wherein the article provision apparatus comprises a sensor configured to sense the article to be provided to the user and read the information on the article when the article is being ejected from the container toward the outside.

15. The system comprising according to claim 14, wherein the sensor is a short-range wireless sensor configured to read, by wirelessly communicating with a wireless communication tag attached to the article, the information on the article when the article is being ejected from the container toward the outside.
